(19) United States
(12) Patent Application Publication
(10) Pub. No.: US 2025/0314228 A1
(43) Pub. Date: Oct. 9, 2025

(54) COMBUSTION STATE DETECTION DEVICE FOR INTERNAL COMBUSTION ENGINE

(71) Applicant: Hitachi Astemo Hanshin, Ltd., Sanda-shi, Hyogo (JP)

(72) Inventors: Yoshihiro SUKEGAWA, Chiyoda-ku, Tokyo (JP); Yukio FUJIYAMA, Sanda-shi, Hyogo (JP); Yoshifumi UCHISE, Sanda-shi, Hyogo (JP); Hideo JITSU, Sanda-shi, Hyogo (JP); Naoki YONEYA, Chiyoda-ku, Tokyo (JP); Kengo KUMANO, Chiyoda-ku, Tokyo (JP)

(73) Assignee: Hitachi Astemo Hanshin, Ltd., Sanda-shi, Hyogo (JP)

(21) Appl. No.: 18/864,737

(22) PCT Filed: Jun. 27, 2023
(86) PCT No.: PCT/JP2023/023866

§ 371 Date: Nov. 11, 2024

(30) Foreign Application Priority Data
Aug. 25, 2022 (JP) 2022-133946

(51) Int. Cl. F02P 17/12; G01M 15/11

(52) U.S. Cl. CPC F02P 17/12; G01M 15/11; F02P 2017/121; F02P 2017/123

(57) ABSTRACT

To provide a combustion state detection device for an internal combustion engine which can detect a misfire regardless of the type of fuel. The combustion state detection device for the internal combustion engine includes: a discharge feature amount acquisition unit; and a determination unit. The discharge feature amount acquisition unit acquires the discharge feature amount based on a voltage value or a current value of an ignition coil connected to a spark plug. The spark plug executes an ignition spark discharge for igniting an air-fuel mixture and a detection spark discharge in the same engine cycle after the ignition spark discharge. The determination unit determines whether the internal combustion engine is in a misfire state or a non-misfire state based on the comparison result between the discharge feature amount of the detection spark discharge and a predetermined determination threshold value.

### TECHNICAL FIELD

This invention relates to a combustion state detection device for an internal combustion engine.

### BACKGROUND ART

There has been disclosed in Patent Literature 1, an ignition device which determines whether an air-fuel mixture is normally ignited. The ignition device disclosed in Patent Literature 1 includes an ignition coil, an igniter unit, a normal discharge control unit, a re-discharge control unit, and a misfire determination unit. The normal discharge control unit causes normal discharge to ignite the air-fuel mixture. After the normal discharge, the re-discharge control unit causes re-ignition to be executed by a primary current smaller than that of the normal discharge. Then, the misfire determination unit detects the presence or absence of re-discharge by secondary current information related to a secondary current after re-ignition or primary voltage information, and determines whether or not the air-fuel mixture has been normally ignited based on the presence or absence of discharge.

When the air-fuel mixture is normally ignited, many ions are generated within a combustion chamber. Since the ions generated by combustion have the effect of lowering a dielectric breakdown voltage at an ignition gap portion, discharge is easily performed by re-ignition when combustion is made normally. On the other hand, since no ions are generated when a misfire occurs, discharge by re-ignition is not made. The ignition device described in Patent Literature 1 determines whether the ignition is normally made by detecting the difference in discharge due to the ions in this manner.

There has been disclosed in Patent Literature 2, a misfire detection device which detects a misfire based on whether or not breakdown (dielectric breakdown) has occurred in the spark plug due to additional ignition during a period in which breakdown assistance by ions is absent.

In the misfire detection device disclosed in Patent Literature 2, it sets the applied voltage during additional ignition (second applied voltage) to an appropriate value lower than the applied voltage during normal ignition (first applied voltage). The appropriate value of the applied voltage (second applied voltage) is assumed to be a value which will not cause breakdown if the air-fuel mixture is normally combusted by normal ignition, but will cause breakdown if the normal ignition causes a misfire. The presence or absence of breakdown of the additional ignition is determined by the voltage or current of the ignition coil.

### CITATION LIST

### Patent Literature

Patent Literature 1: Japanese Unexamined Patent Application Publication No. 2015-200258
Patent Literature 2: Japanese Unexamined Patent Application Publication No. 2021-162011

### SUMMARY OF INVENTION

### Technical Problem

By the way, the use of carbon-neutral fuels such as hydrogen and ammonia generated from renewable energy as fuel for an internal combustion engine has recently been considered. Ions within the combustion chamber are generated by the reaction between hydrocarbons (CH) and oxygen. Fuels such as gasoline and ethanol contain many hydrocarbons in a combustion gas. Therefore, an amount of ions required to determine a combustion state is generated within the combustion chamber. On the other hand, combustion gases such as hydrogen and ammonia contain almost no hydrocarbons. Therefore, when the fuel such as hydrogen or ammonia is burned, the amount of ions generated is extremely small.

The ignition device described in Patent Literature 1 detects differences in discharge due to ions. Therefore, it is difficult to determine whether or not the fuel such as hydrogen or ammonia which is extremely small in the amount of ions generated, has been normally ignited.

The misfire detection device described in Patent Literature 2 is capable of detecting a misfire even if the fuel does not generate ions when burned. However, the dielectric breakdown voltage at the ignition gap portion of the ignition coil is affected by various factors including not only the pressure in the combustion chamber but also the temperature, gas composition, gas flow, and the state of wear and contamination of the spark plug. Therefore, it is difficult to determine an appropriate value for the applied voltage at the time of additional ignition in various operating states and environmental states of the engine. That is, the misfire detection device described in Patent Literature 2 is low in robustness against changes in engine operating states and environmental states.

The present invention has been made in view of the above-described problems, and it is an object of the present invention to provide a combustion state detection device for an internal combustion engine which can detect a misfire regardless of the type of fuel.

### Solution to Problem

In order to solve the above problems and achieve the object, a combustion state detection device for an internal combustion engine which reflects one aspect of the present invention includes: a discharge feature amount acquisition unit which acquires a discharge feature amount based on a voltage value or a current value of an ignition coil connected to a spark plug of the internal combustion engine; and a determination unit which compares the discharge feature amount acquired by the discharge feature amount acquisition unit with a predetermined determination threshold value. The spark plug executes an ignition spark discharge for igniting an air-fuel mixture and a detection spark discharge in the same engine cycle after the ignition spark discharge. The discharge feature amount acquisition unit acquires the discharge feature amount based on the voltage value or current value of the ignition coil in the detection spark discharge. The determination unit determines whether the internal combustion engine is in a misfire state or a non-misfire state based on the comparison between the discharge feature amount and the predetermined determination threshold value.

### Advantageous Effects of Invention

According to the present invention, it is possible to detect a misfire regardless of the type of fuel.

### BRIEF DESCRIPTION OF DRAWINGS

FIG. 1 is a diagram showing a configuration example of an internal combustion engine according to a first embodiment.

FIG. 2 is a diagram showing a configuration example of an ignition unit and a combustion detection unit according to an embodiment of the present invention.

FIG. 3 is a diagram showing an example in which a part of the combustion detection unit according to the embodiment of the present invention is arranged inside an ECU.

FIG. 4 is a diagram showing a configuration example of an ignition unit and a combustion detection unit according to the first embodiment.

FIG. 5 is a diagram showing an example in which a part of the combustion detection unit according to the first embodiment is arranged inside an ECU.

FIG. 6 is a diagram showing a circuit configuration example of an ignition unit and a voltage detection unit according to the first embodiment.

FIG. 7 is an explanatory diagram showing an example of the timing of an ignition signal and the behaviors of a coil voltage, a current, and in-cylinder pressure according to the first embodiment.

FIGS. 8A and 8B are explanatory diagrams showing an example of the behaviors of a primary voltage and a secondary current of a spark discharge for detection according to the first embodiment.

FIG. 9 is an explanatory diagram showing an example of the elongation of a general discharge path.

FIGS. 10A, 10B, and 10C are explanatory diagrams showing an example of the relationship between the in-cylinder pressure, the amount of elongation of a discharge path, a peak voltage at the end of discharge, and a discharge period according to the first embodiment.

FIG. 11 is a diagram showing a configuration example of a peak voltage acquisition unit and a determination unit according to the first embodiment.

FIG. 12 is an explanatory diagram showing an example of the operations of the peak voltage acquisition unit and the determination unit according to the first embodiment.

FIG. 13 is a flowchart showing a procedure of misfire detection processing based on a peak voltage according to the first embodiment.

FIG. 14 is a diagram showing a configuration example of an ignition unit and a combustion detection unit according to a second embodiment.

FIG. 15 is a diagram showing an example in which a part of the combustion detection unit according to the second embodiment is arranged inside an ECU.

FIG. 16 is a diagram showing a circuit configuration example of an ignition unit and a current detection unit according to the second embodiment.

FIG. 17 is a diagram showing a configuration example of a discharge period acquisition unit and a determination unit according to the second embodiment.

FIG. 18 is an explanatory diagram showing an example of the operations of the discharge period acquisition unit and the determination unit according to the second embodiment.

FIG. 19 is a flowchart showing a procedure of misfire detection processing based on a discharge period according to the second embodiment.

FIG. 20 is a diagram showing a configuration example of an ignition unit and a combustion detection unit according to a third embodiment.

FIG. 21 is a diagram showing an example in which a part of the combustion detection unit according to the third embodiment is arranged inside an ECU.

FIG. 22 is a diagram showing a configuration example of a discharge period acquisition unit and a determination unit according to the third embodiment.

FIG. 23 is an explanatory diagram showing an example of the operations of the discharge period acquisition unit and the determination unit according to the third embodiment.

FIG. 24 is a flowchart showing a procedure of misfire detection processing based on a discharge period according to the third embodiment.

FIG. 25 is a diagram showing a configuration example of an ignition unit and a combustion detection unit according to a fourth embodiment.

FIG. 26 is a diagram showing an example in which a part of the combustion detection unit according to the fourth embodiment is arranged inside an ECU.

FIG. 27 is an explanatory diagram showing an averaging period and an average voltage of a primary voltage of spark discharge for detection according to the fourth embodiment.

FIG. 28 is an explanatory diagram showing an example of the relationship between in-cylinder pressure and the average voltage according to the fourth embodiment.

FIG. 29 is a flowchart showing a procedure of misfire detection processing based on the average voltage according to the fourth embodiment.

FIG. 30 is a flowchart showing a procedure of calculating the average voltage according to the fourth embodiment.

FIG. 31 is an explanatory diagram showing a configuration example of an ignition unit and a combustion detection unit according to a fifth embodiment.

FIG. 32 is a flowchart showing a procedure of misfire detection processing based on an average voltage and a peak voltage according to the fifth embodiment.

FIGS. 33A and 33B are explanatory diagrams showing an example of the behavior of a primary voltage in spark discharge for detection when detection spark discharge timings according to the fifth embodiment are different.

FIG. 34 is an explanatory diagram showing examples of misfire detection accuracy when misfire detection is performed based on a peak voltage and when misfire detection is performed based on an average voltage with respect to changes in detection spark discharge timing according to the fifth embodiment.

FIG. 35 is a diagram showing a configuration example of an ignition unit and a combustion detection unit according to a sixth embodiment.

FIGS. 36A and 36B are explanatory diagrams showing examples of the behavior of a primary voltage of spark discharge for detection, the time differential behavior of the primary voltage, and an averaging period of the time differential of the primary voltage according to the sixth embodiment.

FIG. 37 is an explanatory diagram showing an example of the relationship between in-cylinder pressure and a voltage change rate according to the sixth embodiment.

FIG. 38 is a flowchart showing a procedure of misfire detection processing based on the voltage change rate according to the sixth embodiment.

FIG. 39 is a flowchart showing a procedure of calculating the voltage change rate according to the sixth embodiment.

FIGS. 40A, 40B, and 40C are explanatory diagrams showing a method of changing a peak voltage comparison value and a discharge period comparison value with respect to changes in average engine torque, average engine rotational speed, and average intake pressure according to the present invention.

FIGS. 41A, 41B, and 41C are explanatory diagrams showing a method of changing an average voltage comparison value and a voltage change rate comparison value with respect to changes in average engine torque, average engine rotational speed, and average intake pressure according to the present invention.

### DESCRIPTION OF EMBODIMENTS

One embodiment of the invention will now be described with reference to the accompanied drawings. In the present specification and the accompanying drawings, components having substantially the same functions or configurations are given the same reference numerals, and their dual description will be omitted.

### First Embodiment

### [Configuration of Internal Combustion Engine]

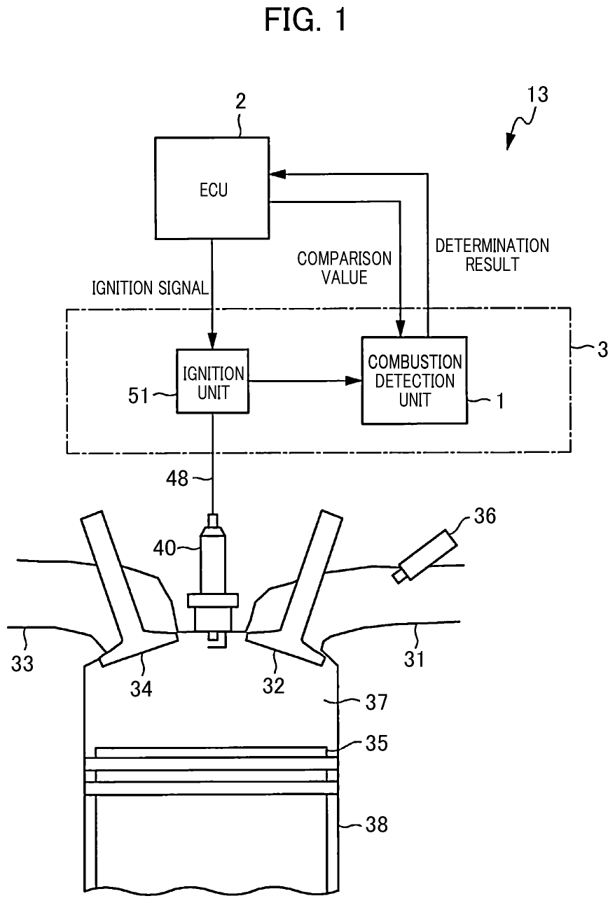

First, the configuration of an internal combustion engine according to a first embodiment will be described using FIG. 1.

FIG. 1 is an overall configuration diagram showing an example of the configuration of the internal combustion engine according to the first embodiment of the present invention.

As shown in FIG. 1, the internal combustion engine 13 includes a cylinder 38, a piston 35 which slides within the cylinder 38, an intake valve 32, an exhaust valve 34, and a spark plug 40. A combustion chamber 37 facing the piston 35 is formed within the cylinder 38. The combustion chamber 37 communicates with an intake manifold 31 and an exhaust manifold 33.

The intake valve 32 opens and closes communication between the intake manifold 31 and the combustion chamber 37. The exhaust valve 34 opens and closes communication between the exhaust manifold 33 and the combustion chamber 37. The intake manifold 31 is provided with an injector 36 which injects fuel. A mixture of fuel injected by the injector 36 and air taken in from the intake manifold 31 is supplied to the combustion chamber 37.

The fuel supplied to the internal combustion engine 13 by the injector 36 is combustible liquid fuel or gas fuel such as methane gas, propane gas, hydrogen, ammonia, synthetic hydrocarbon fuel (eFuel), etc., in addition to gasoline, ethanol, and the like. Note that the emission of carbon dioxide from the internal combustion engine can be extremely reduced by using hydrogen, ammonia, eFuel, or the like generated from renewable energy such as solar power generation or wind power generation as fuel.

Further, the internal combustion engine 13 includes an ignition device 3. The ignition device 3 includes an ignition unit 51 which applies a high voltage to the spark plug 40, and a combustion detection unit 1 which detects a combustion state of the internal combustion engine 13. The combustion detection unit 1 corresponds to a combustion state detection device according to the present invention.

When the high voltage is applied from the ignition unit 51, the spark plug 40 generates a spark discharge to ignite the air-fuel mixture in the combustion chamber 37. The ignition unit 51 is electrically connected to an ECU (Engine Control Unit) 2. The ignition unit 51 applies a high voltage to the spark plug 40 through a high tension cord 48 based on an ignition signal transmitted from the ECU 2. The combustion detection unit 1 receives voltage information or current information from the ignition unit 51, detects the combustion state of the internal combustion engine 13 based on the voltage information or the current information, and sends the result of detection thereof to the ECU 2.

When the spark plug 40 generates a spark discharge, the air-fuel mixture in the combustion chamber 37 is ignited and burned. The air-fuel mixture burned in the combustion chamber 37 pushes down the piston 35 and rotates an unillustrated crankshaft. As a result, the power generated by the internal combustion engine 13 is take out to the outside.

### [Configurations of Ignition Unit and Combustion Detection Unit]

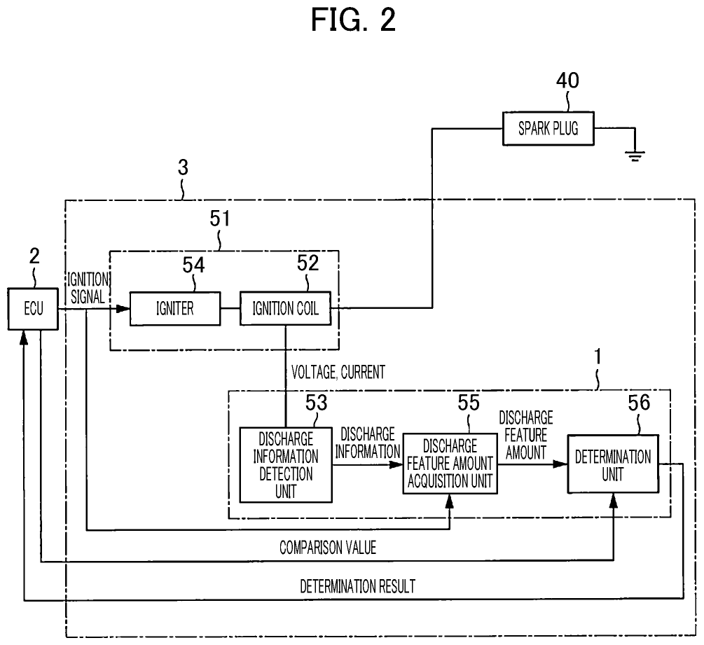

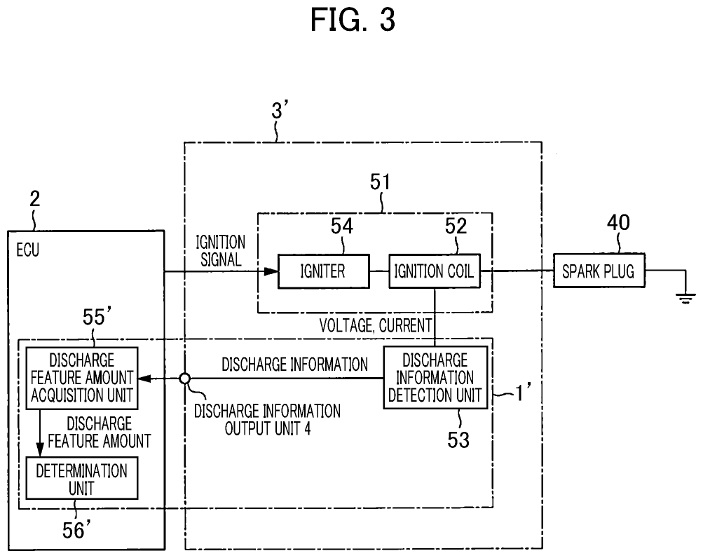

Next, the configurations of the ignition unit and the combustion detection unit of the ignition device according to the embodiment of the present invention will be described using FIGS. 2 and 3.

FIG. 2 is an explanatory diagram showing a configuration example of the ignition unit 51 and the combustion detection unit 1 in the ignition device 3 according to the embodiment of the present invention. FIG. 3 is an explanatory diagram showing an example in which some of the components of the combustion detection unit according to the embodiment of the present invention are arranged inside the ECU 2.

As shown in FIG. 2, the ignition unit 51 includes an igniter 54 and an ignition coil 52. The igniter 54 receives an ignition signal sent from the ECU 2. The ignition coil 52 applies a high voltage to the spark plug 40.

The combustion detection unit 1 includes a discharge information detection unit 53, a discharge feature amount acquisition unit 55, and a determination unit 56. The discharge information detection unit 53 detects the voltage (primary voltage or secondary voltage) of the ignition coil 52 or its current (secondary current), and sends it as discharge information to the discharge feature amount acquisition unit 55. The discharge feature amount acquisition unit 55 acquires a discharge feature amount based on the input discharge information and sends it to the determination unit 56. The determination unit 56 determines whether or not the internal combustion engine 13 has misfired, based on the input discharge feature amount and the comparison value received from the ECU 2, and sends its determination result to the ECU 2.

FIG. 2 shows an example in which all the components of the combustion detection unit 1 are arranged inside the ignition device 3. However, some of the components of the combustion detection unit may be arranged inside the ECU 2. As shown in FIG. 3, the ignition device 3′ includes an ignition unit 51 and a discharge information detection unit 53.

The combustion detection unit 1′ is comprised of the discharge information detection unit 53 arranged inside the ignition device 3′, and a discharge feature amount acquisition unit 55′ and a determination unit 56′ arranged inside the ECU 2. The combustion detection unit 1′ corresponds to a combustion state detection device according to the present invention. Discharge information output from the discharge information detection unit 53 is sent to the ECU 2 through a discharge information output unit 4.

When the discharge feature amount acquisition unit 55′ and the determination unit 56′ are arranged inside the ECU 2 like the combustion detection unit 1′, the processing of the discharge feature amount acquisition unit 55′ and the determination unit 56′ can be executed by software running on the ECU 2. In this case, for example, the conditions for misfire determination can be flexibly changed according to the operating state of the internal combustion engine 13. Therefore, the detection of the combustion state (misfire determination) can be optimized.

### First Embodiment

### [Configurations of Ignition Unit and Combustion Detection Unit]

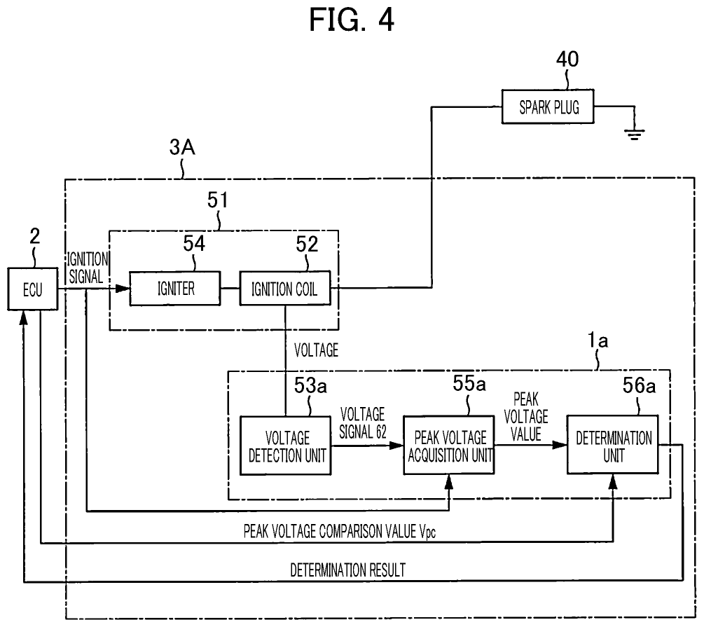

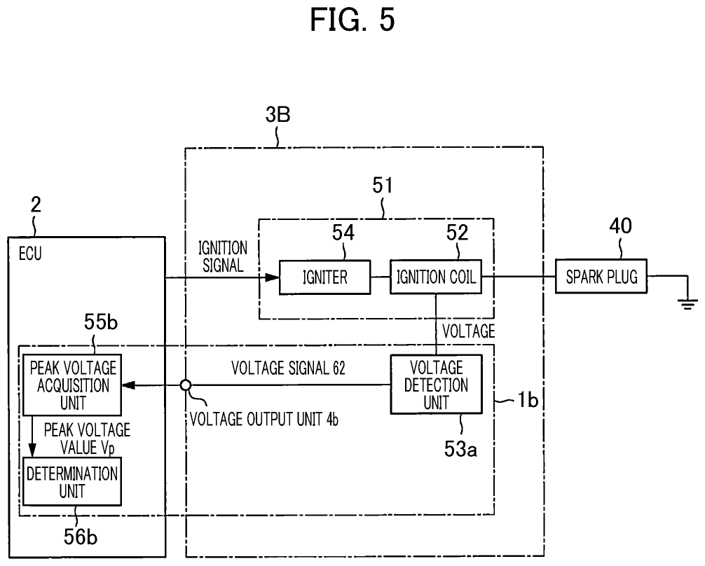

Next, the configurations of the ignition unit and the combustion detection unit of the ignition device according to the first embodiment will be described using FIGS. 4 and 5.

FIG. 4 is an explanatory diagram showing a configuration example of the ignition unit 51 and the combustion detection unit 1a of the ignition device 3A according to the first embodiment. FIG. 5 is an explanatory diagram showing an example in which some of the components of the combustion detection unit according to the first embodiment are arranged inside the ECU 2.

As shown in FIG. 4, the ignition unit 51 includes an igniter 54 and an ignition coil 52. The igniter 54 receives an ignition signal sent from the ECU 2. The ignition coil 52 applies a high voltage to the spark plug 40.

The combustion detection unit 1a includes a voltage detection unit 53a, a peak voltage acquisition unit 55a, and a determination unit 56a. The voltage detection unit 53a detects the voltage of the ignition coil 52 (primary voltage or secondary voltage with reversed polarity), and sends a voltage signal 62 to the peak voltage acquisition unit 55a. Note that it is more desirable for the voltage detection unit 53a to detect the primary voltage of the ignition coil 52 than to detect the secondary voltage of the ignition coil 52. The secondary voltage of the ignition coil 52 normally reaches tens of thousands of volts. On the other hand, the primary voltage of the ignition coil 52 is normally several hundred volts. Therefore, when the voltage detection unit 53a detects the primary voltage of the ignition coil 52, the voltage resistance of hardware can be lowered, and hardware costs can be reduced, as compared to when the voltage detection unit 53a detects the secondary voltage of the ignition coil 52. Further, when the voltage detection unit 53a detects the primary voltage of the ignition coil 52, it is possible to improve safety and reliability compared to the case in which the voltage detection unit 53a detects the secondary voltage of the ignition coil 52.

The peak voltage acquisition unit 55a acquires a peak voltage value based on the input voltage signal 62 and sends it to the determination unit 56a. The determination unit 56a determines whether the internal combustion engine 13 has misfired, based on the input peak voltage value and the peak voltage comparison value received from the ECU 2, and sends the result of its determination to the ECU 2.

FIG. 4 shows an example in which all the components of the combustion detection unit 1a are arranged inside the ignition device 3A. However, some of the components of the combustion detection unit may be arranged inside the ECU 2. As shown in FIG. 5, an ignition device 3B includes an ignition unit 51 and a voltage detection unit 53a.

A combustion detection unit 1b is comprised of a voltage detection unit 53a arranged inside the ignition device 3B, and a peak voltage acquisition unit 55b and a determination unit 56b arranged inside an ECU 2. The combustion detection unit 1b corresponds to a combustion state detection device according to the present invention. The voltage detection unit 53a detects the voltage of an ignition coil 52 (primary voltage or secondary voltage with reversed polarity). A voltage signal 62 output from the voltage detection unit 53a is sent to the ECU 2 through a voltage output unit 4b. Note that it is desirable that the voltage detection unit 53a steps down the voltage signal 62 to an appropriate voltage range (for example, a range of 0 to 5 volts) so that the ECU 2 can easily handle the voltage signal 62.

A voltage value of the voltage on the primary side, which is the low voltage side of the ignition coil 52 usually reaches a maximum of several hundred volts. When this voltage value is directly sent to the ECU 2 as the voltage signal 62, the ECU 2 requires high voltage resistance and a voltage step-down circuit, and thereby the hardware cost of the ECU 2 is increased. Therefore, the voltage detection unit 53a steps down the detected voltage of the ignition coil 52 to a voltage range (range of 0 to 5 volts) normally handled inside the ECU 2. Thus, it is possible to suppress an increase in the hardware cost of the ECU 2.

When the peak voltage acquisition unit 55b and the determination unit 56b are arranged inside the ECU 2 as in the combustion detection unit 1b, the processing of the peak voltage acquisition unit 55b and the determination unit 56b can be executed by software running on the ECU 2. In this case, for example, the conditions for misfire determination can be flexibly changed according to the operating state of the internal combustion engine 13. Therefore, the detection of the combustion state (misfire determination) can be optimized.

### [Circuit Configurations of Ignition Unit and Voltage Detection Unit]

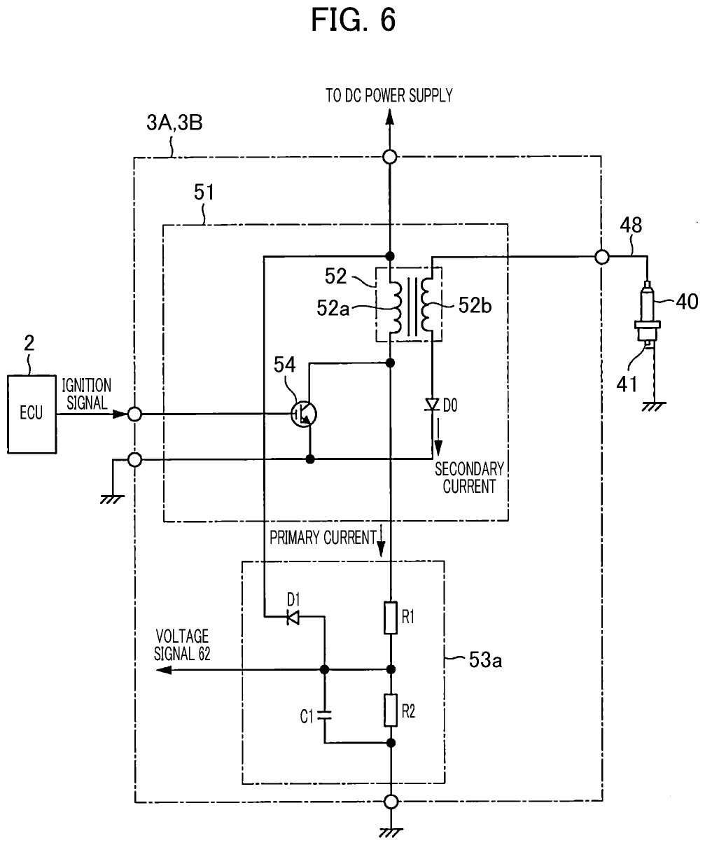

Next, the circuit configurations of the ignition unit 51 and the voltage detection unit 53a will be described using FIG. 6.

FIG. 6 is an explanatory diagram showing a circuit configuration example of the ignition unit 51 and the voltage detection unit 53a.

As shown in FIG. 6, the ignition unit 51 includes an ignition coil 52 and an igniter 54. Further, the voltage detection unit 53a has a voltage dividing resistor R1 and a voltage dividing resistor R2 connected in series.

In the ignition unit 51, one end of a primary coil 52a of the ignition coil 52 is connected to an unillustrated battery (DC power supply). Thus, a predetermined voltage (for example, 12V) is applied to the primary coil 52a and thereby, a primary current flows. The other end of the primary coil 52a is connected to a collector terminal of the igniter 54 and one end of the voltage dividing resistor R1 of the voltage detection unit 53a. The other end of the primary coil 52a is grounded via an emitter terminal of the igniter 54. A transistor, a field effect transistor (FET), or the like is used for the igniter 54. A base terminal of the igniter 54 is connected to the ECU 2. A secondary coil 52b of the ignition coil 52 shares a magnetic circuit and magnetic flux with the primary coil 52a. The ratio of the number of turns of the secondary coil 52b to the primary coil 52a is set to about 100, for example. One end of the secondary coil 52b is connected to an electrode of a spark plug 40 through a high tension cord 48. The other end of the secondary coil 52b is connected to an anode of a diode DO. A cathode of the diode D0 is grounded.

While the ignition signal is being sent from ECU 2 to the base terminal of the igniter 54, i.e., while the ignition signal is turned on, the collector and emitter terminals of the igniter 54 are brought into a conductive state. Thus, the primary current is output from the collector terminal of the igniter 54 to the emitter terminal thereof via the primary coil 52a.

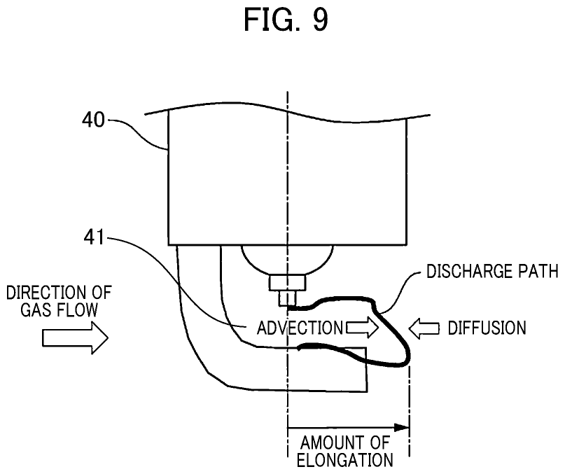

When the sending of the ignition signal from the ECU 2 to the base terminal of the igniter 54 stops, i.e., when the ignition signal is turned off, the primary current flowing through the igniter 54 is cut off. At this time, a magnetic field change occurs in the primary coil 52a, and a primary voltage is generated due to self-induction. Then, a high secondary voltage corresponding to the winding number ratio is generated in the secondary coil 52b due to mutual induction. Consequently, a secondary voltage is applied to the spark plug 40, and a spark discharge occurs in an ignition gap 41 (refer to FIG. 9) of the spark plug 40. Further, the secondary current generated by the secondary voltage induced in the secondary coil 52b flows to the ground via the diode DO.

Further, when the ignition signal is turned from on to off and a secondary voltage is generated, a primary voltage is induced by mutual induction of the ignition coil 52. The primary current generated by the primary voltage induced in the primary coil 52a flows to the ground through the voltage dividing resistor R1 and the voltage dividing resistor R2 of the voltage detection unit 53a.

The voltage detection unit 53a sends out the voltage between the voltage dividing resistor R1 and the voltage dividing resistor R2 as a voltage signal 62. Assuming that the voltage of the primary coil 52a is V1, the voltage Vs of the voltage signal 62 is calculated by a formula (1).

$$\begin{matrix}[ Formula 1 ] & \\ Vs = V 1 \times R 2 / ( R 1 + R 2 ) & ( 1 )\end{matrix}$$

The voltage V1 of the primary coil 52a (primary coil voltage V1) generated by mutual induction during spark discharge generally reaches a maximum of several hundred volts. Therefore, the voltage detection unit 53a steps down the primary coil voltage V1 to an easy-to-handle low voltage (e.g., about 5 volts at most) using the voltage dividing resistors R1 and R2, and sends it out as a voltage signal 62.

### [Timing of Ignition Signal and Behaviors of Coil Voltage, Current, and In-Cylinder Pressure]

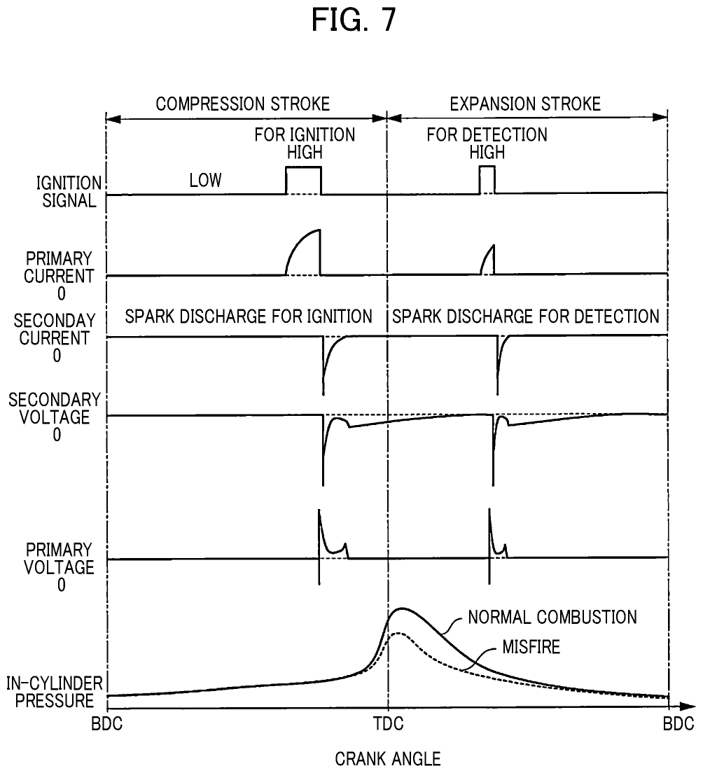

Next, a description will be made about an example of the timing of the ignition signal and the behaviors of the coil voltage, current, and in-cylinder pressure according to the present embodiment using FIG. 7.

FIG. 7 is an explanatory diagram showing the example of the ignition signal timing and the behaviors of the coil voltage, current, and in-cylinder pressure according to the embodiment of the present invention.

The horizontal axis of a graph shown in FIG. 7 indicates a crank angle, the left end of the graph indicates a compression start timing (compression bottom dead center), and the right end of the graph indicates an expansion end timing (expansion bottom dead center). The graph shown in FIG. 7 shows, from the top, the ignition signal sent to the ignition unit 51 by the ECU 2, the primary current of the coil, the secondary current of the coil, the secondary voltage of the coil, the primary voltage of the coil, and the time change in in-cylinder pressure. Further, regarding the in-cylinder pressure, there are shown the case in which combustion occurs normally (solid line), and the case in which a misfire occurs (broken line).

As shown in FIG. 7, in the present embodiment, the ECU 2 first sends an ignition signal (ignition signal for ignition) for igniting the air-fuel mixture to the ignition unit 51 from the latter half of a compression stroke to the early stage of an expansion stroke (for example, from 40 degrees before the compression top dead center to 20 degrees after the compression top dead center). When the ignition signal for ignition changes from Low (OFF) to High (ON), the igniter 54 is brought into a conducting state, and thereby, a primary current flows through the primary coil 52a. When the primary current flows through the primary coil 52a, magnetic energy is stored in the ignition coil 52.

Next, when the ignition signal for ignition switches from High to Low, the primary current flowing through the igniter 54 is cut off, so that a high voltage is induced in the secondary coil 52b due to mutual induction. This high voltage causes dielectric breakdown (breakdown) in the ignition gap 41 (refer to FIG. 9) of the spark plug 40, and a spark discharge for ignition (ignition spark discharge) occurs. When the ignition spark discharge occurs, a secondary current flows, and a primary voltage is further induced by mutual induction due to the coil. At this time, a change in the primary voltage becomes a behavior corresponding to a change in the secondary voltage. That is, when the secondary voltage becomes high, the primary voltage also increases correspondingly.

As the ignition spark discharge occurs and the secondary current flows, the magnetic energy stored in the ignition coil 52 decreases. When the secondary voltage becomes lower than the dielectric breakdown voltage of the ignition gap 41 as the magnetic energy decreases, the ignition spark discharge is terminated. As a result, the secondary current and the primary voltage become approximately zero.

Thereafter, during the expansion stroke, the ECU 2 sends an ignition signal (ignition signal for detection) for detecting a misfire to the ignition unit 51. When the detection ignition signal changes from Low (OFF) to High (ON), the igniter 54 is brought into a conducting state, and thereby, a primary current flows through the primary coil 52a. When the primary current flows through the primary coil 52a, magnetic energy is stored in the ignition coil 52.

Next, when the detection ignition signal switches from High to Low, the primary current flowing through the igniter 54 is cut off, so that a high voltage is applied to the secondary coil 52b due to mutual induction. This high voltage causes dielectric breakdown (breakdown) in the ignition gap 41 of the spark plug 40, and a spark discharge for detection (detection spark discharge) is generated. When the detection spark discharge is generated, a secondary current flows, and a primary voltage is further induced by mutual induction due to the coil. At this time, a change in the primary voltage becomes a behavior corresponding to a change in the secondary voltage. That is, when the secondary voltage becomes high, the primary voltage also increases correspondingly.

As the detection spark discharge is generated, and the secondary current flows, the magnetic energy stored in the ignition coil 52 decreases. As the magnetic energy decreases, the detection spark discharge is terminated when the secondary voltage becomes lower than the dielectric breakdown of the ignition gap 41. As a result, the secondary current and the primary voltage become approximately zero.

It is desirable that the timing at which the detection ignition signal is sent out is after the timing when flame propagation within the combustion chamber is almost completed during the normal combustion, and is the timing at which the difference between the in-cylinder pressure during the normal combustion and at the time of a misfire at the timing at which the ignition signal is sent out, becomes a predetermined value or more (for example, 0.1 MPa or more).

When the timing of sending out the detection ignition signal is too early, the temperature in the cylinder and the distribution of the gas composition containing ions at the discharge timing for detection may become uneven, or the turbulence of a gas flow may strengthen. These affects the voltage and discharge period of the detection spark discharge. Therefore, when the timing at which the ignition signal for detection is sent out is too early, there is a risk that the reliability of misfire detection may be degraded.

Further, when the timing of sending the detection ignition signal is excessively late, the difference between the in-cylinder pressure during the normal combustion and during the misfire at the detection discharge timing becomes small. This results in a reduction in the SN ratio at the misfire detection. Therefore, when the timing at which the detection ignition signal is sent out is excessively late, there is a risk that the reliability of misfire detection may be degraded.

According to the results of experiment by the inventors, it is desirable to set the sending timing of the detection ignition signal to be within the range from a 20° advance timing with respect to the time of a combustion mass fraction 90% (MFB (Mass Fraction Burnt) 90) to a 40° retard timing with respect to the time of MFB90.

When the timing of sending the detection ignition signal is earlier than the 20° advance timing with respect to the time of MFB90, the temperature in the cylinder and the distribution of the gas composition containing ions at the discharge timing for detection may become uneven, or the turbulence of a gas flow may strengthen. As a result, there is a risk that the reliability of misfire detection may decrease. On the other hand, when the timing of sending the detection ignition signal is later than the 40° retard timing with respect to the timing of MFB90, the difference between the in-cylinder pressures during the normal combustion and during the misfire becomes small. Thus, there is a risk that the SN ratio in misfire detection may be reduced, and the reliability of misfire detection may be degraded.

Further, the ON time of the detection ignition signal (the time taken to charge magnetic energy to the coil) is set so as not to become excessively long within the range in which spark discharge (breakdown) occurs regardless of the misfire or normal combustion. According to the results of experiment by the inventors, the desirable ON time of the detection ignition signal is approximately 0.2 ms to 1 ms.

When the ON time of the detection ignition signal is made excessively shot (for example, 0.1 ms), the secondary voltage generated by mutual induction becomes lower than the dielectric breakdown voltage, and there is a risk that a spark discharge (breakdown) will not occur. On the other hand, when the ON time of the detection ignition signal is made excessively long (for example, 2 ms), the probability of occurrence of re-discharge (restrike) or discharge path replacement (short circuit) increases as the discharge period becomes longer, and there is a risk that the reliability of misfire detection may be degraded. Further, when the ON time of the detection ignition signal is made excessively long, the amount of power consumed by the detection spark discharge increases, and there is a risk that fuel efficiency may deteriorate. In addition, there is a risk that the wear of the electrode of the spark plug due to the discharge will increase, and the cost required for maintenance of the internal combustion engine will be higher.

Moreover, it is desirable that the ON time of the detection ignition signal is changed based on the timing of sending out the detection ignition signal or the load of the internal combustion engine. More specifically, it is desirable that when the timing at which detection ignition signal is sent out is on the advance side of the expansion stroke, the ON time of the detection ignition signal is made longer than when the timing at which the detection ignition signal is sent out is on the retard side of the expansion stroke. Further, it is desirable that when the load (torque) of the internal combustion engine is high, the ON time of the detection ignition signal is made longer than when the load of the internal combustion engine is low.

When the timing at which the detection ignition signal is sent out is on the advance side of the expansion stroke, the in-cylinder pressure at the timing at which the detection ignition signal is sent out becomes higher than when the timing at which the detection ignition signal is sent out is on the retard side of the expansion stroke. As a result, the dielectric breakdown voltage for generating the detection spark discharge becomes high. Therefore, when the timing at which the detection ignition signal is sent out is on the advance side of the expansion stroke, the ON time of the detection ignition signal is made longer than when the timing at which the detection ignition signal is sent out is on the retard side of the expansion stroke. This can reduce the risk of a spark discharge (breakdown) not occurring.

When the load (torque) of the internal combustion engine is high, the in-cylinder pressure at the timing when the detection ignition signal is sent out becomes higher than when the load of the internal combustion engine is low. As a result, the dielectric breakdown voltage for generating the detection spark discharge becomes high. Therefore, when the load of the internal combustion engine is high, the ON time of the detection ignition signal is made longer than when the load of the internal combustion engine is low. This can reduce the risk of a spark discharge (breakdown) not occurring.

### [Behaviors of Primary Voltage and Secondary Current of Spark Discharge for Detection]

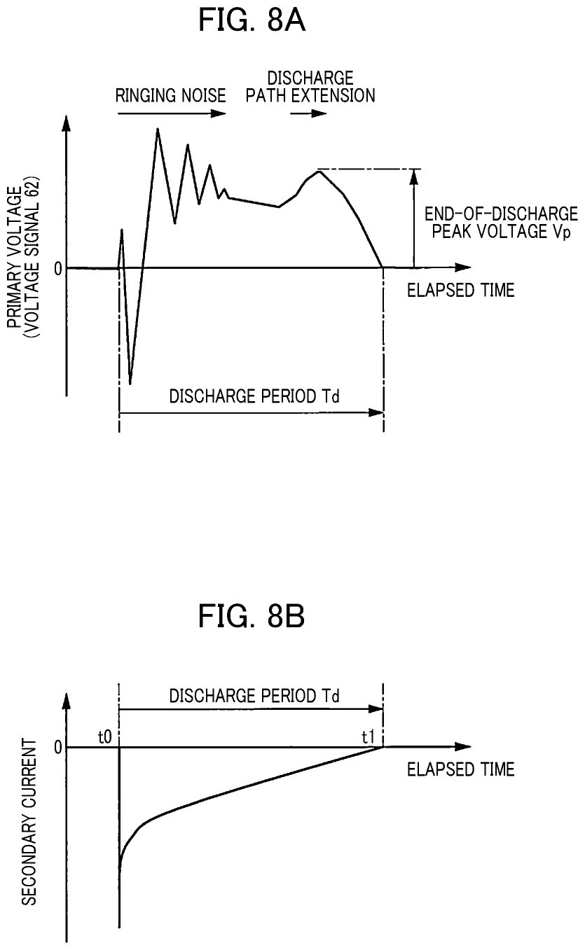

Next, the behaviors of the primary voltage and the secondary current of the detection spark discharge in the present embodiment will be described using FIGS. 8A and 8B.

FIGS. 8A and 8B are explanatory diagrams showing an example of the behaviors of the primary voltage and the secondary current of the detection spark discharge according to the first embodiment.

The horizontal axis of the graph shown in each of FIGS. 8A and 8B indicates an elapsed time. FIG. 8A shows the primary voltage (voltage signal 62) in the detection spark discharge detected by the voltage detection unit 53a. FIG. 8B shows a temporal change in the secondary current of the detection spark discharge. Here, to indicates the timing provided to start the detection spark discharge, and t1 indicates the timing provided to end the detection spark discharge. The start timing to of the detection spark discharge is defined as the timing at which the absolute value of the secondary current becomes a predetermined value or greater, or the timing at which the detection ignition signal changes from ON to OFF. The discharge end timing t1 of the detection spark discharge is defined as the timing when the absolute value of the secondary current becomes less than or equal to a predetermined value. Further, the discharge period Td of the detection spark discharge is defined as the difference between t1 and t0.

As shown in FIG. 8A, immediately after the detection spark discharge start timing to, the primary voltage (voltage signal 62) shows a behavior which oscillates greatly. This is ringing noise generated by the resonance of a stray capacitance and an inductance included in the ignition unit 51, the voltage detection unit 53a, and the like. This ringing noise decreases in the middle of the discharge period. The primary voltage increases at the end of the detection spark discharge and becomes approximately 0 at the discharge end timing t1. That is, at the end of the detection spark discharge, a peak value of the primary voltage (hereinafter referred to as an end-of-discharge peak voltage Vp) appears. Note that the end of the detection spark discharge approximately indicates between 60% and 100% of the discharge period Td (the discharge start timing of the detection spark discharge is 0% and the discharge end timing of the detection spark discharge is 100%).

Thus, the rise in the voltage at the discharge end is due to the elongation effect of the discharge path. In the present embodiment, the combustion state is detected based on the end-of-discharge peak voltage Vp in the detection spark discharge. That is, the peak voltage acquisition units 55a and 55b (refer to FIG. 4 or FIG. 5) acquire the end-of-discharge peak voltage Vp in the detection spark discharge.

Note that the end-of-discharge peak voltage Vp in the detection spark discharge acquired by the peak voltage acquisition units 55a and 55b may be acquired from the end-of-discharge peak voltage of the secondary voltage of the ignition coil 52. However, since the secondary voltage of the ignition coil 52 reaches a maximum of tens of thousands of volts, it is desirable to obtain the end-of-discharge peak voltage Vp from the primary voltage which is on the low voltage side and easy to handle from the viewpoint of reducing the cost of manufacturing the circuit.

### [Elongation of Discharge Path]

Next, the elongation of the discharge path will be described using FIG. 9.

FIG. 9 is an explanatory diagram showing an example of the elongation of a general discharge path.

As shown in FIG. 9, when a spark discharge occurs in the ignition gap 41 of the spark plug 40, the discharge path is elongated due to the gas flow in the ignition gap 41. FIG. 9 shows an example in which gas flows from left to right. Therefore, the discharge path extends to the right which is the direction of the gas flow.

When the distance from the center of the electrode of the spark plug 40 to the farthest part of the discharge path is defined as the amount of elongation, the amount of elongation increases as time elapses during discharge and reaches its maximum immediately before the end of discharge. Further, the electrical resistance of the ignition gap 41 is approximately proportional to the amount of elongation of the discharge path, and the higher the elongation amount, the higher the electrical resistance of the ignition gap 41.

The secondary voltage of the ignition coil 52 is determined by the product of the electrical resistance of the ignition gap 41 and the secondary current. At the end of discharge, the electrical resistance of the ignition gap 41 increases significantly due to the elongation of the discharge path with respect to a decrease in the secondary current, so that a peak occurs in the secondary voltage. Then, the primary voltage (voltage signal 62) excited by mutual induction is approximately proportional to the secondary voltage. Therefore, at the end of discharge, a peak also occurs in the primary voltage (voltage signal 62), which becomes the end-of-discharge peak voltage Vp (refer to FIG. 8A). That is, there is a positive correlation between the amount of elongation of the discharge path and the end-of-discharge peak voltage Vp, and the greater the amount of elongation of the discharge path, the higher the end-of-discharge peak voltage Vp.

### [Relationship Between In-Cylinder Pressure, Elongation Amount, End-of-Discharge Peak Voltage Vp, and Discharge Period Td]

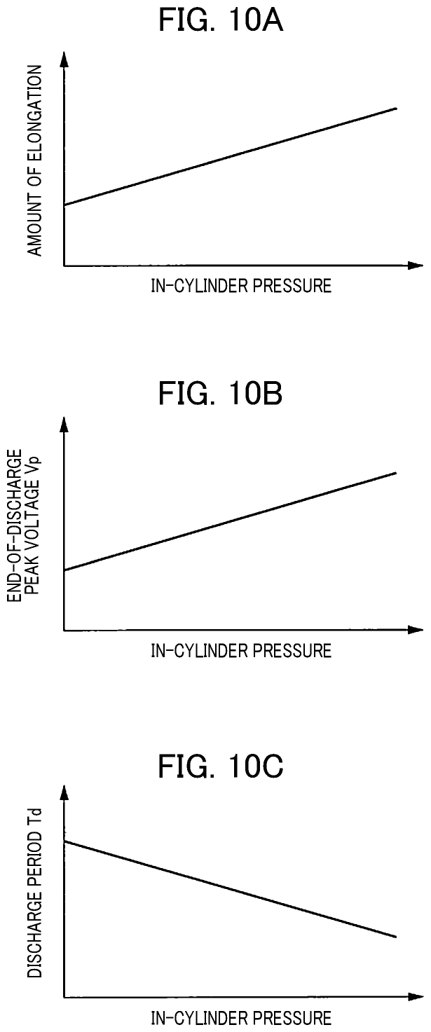

Next, the relationship between the in-cylinder pressure, the amount of elongation, the end-of-discharge peak voltage Vp, and the discharge period Td will be described using FIGS. 10A, 10B, and 10C.

FIGS. 10A, 10B, and 10C are explanatory diagrams showing examples of the relationship between the in-cylinder pressure, the amount of elongation, the end-of-discharge peak voltage Vp, and the discharge period Td according to the present embodiment.

FIG. 10A shows an example of the relationship between the in-cylinder pressure and the amount of elongation of the discharge path in the detection spark discharge. FIG. 10B shows an example of the relationship between the in-cylinder pressure and the end-of-discharge peak voltage Vp in the detection spark discharge. FIG. 10C shows an example of the relationship between the in-cylinder pressure and the discharge period Td in the detection spark discharge.

As shown in FIG. 10A, there is a high correlation between the in-cylinder pressure and the amount of elongation of the discharge path, and the lower the in-cylinder pressure, the smaller the amount of elongation of the discharge path. This is because the elongation of the discharge path is determined by the balance between the advection effect due to the gas flow and the diffusion effect of electrons. To describe in more detail, the advection effect acts in a direction to increase the elongation of the discharge path. On the other hand, the electron diffusion effect acts in a direction to reduce the elongation of the discharge path. The electron diffusion effect becomes larger as the in-cylinder pressure decreases. Therefore, if the advection effect is constant (gas flow rate is constant), the amount of elongation becomes smaller as the in-cylinder pressure decreases.

As described above, there is a positive correlation between the amount of elongation of the discharge path and the end-of-discharge peak voltage Vp. Therefore, as shown in FIG. 10B, a positive correlation is also obtained between the in-cylinder pressure and the end-of-discharge peak voltage Vp.

As shown in FIG. 10C, a negative correlation is obtained between the in-cylinder pressure and the discharge period Td. That is, the discharge period Td becomes longer as the in-cylinder pressure is lower. Discharge output (discharge energy per unit time) is determined by the product of the secondary voltage and the secondary current. When the in-cylinder pressure is lowered and the amount of elongation of the discharge path decreases, the secondary voltage is lowered, thereby resulting in a decrease in the discharge output. Therefore, when the in-cylinder pressure is lowered, the consumption rate of the electromagnetic energy stored in the ignition coil 52 is reduced, and the discharge period Td becomes longer.

During a misfire, the in-cylinder pressure at the timing of the detection spark discharge becomes lower than during the normal combustion. Therefore, during the misfire, the end-of-discharge peak voltage Vp in the detection spark discharge becomes lower than during the normal combustion. Further, during the misfire, the discharge period Td of the detection spark discharge becomes longer than during the normal combustion.

Therefore, the upper limit value of the end-of-discharge peak voltage Vp at the time of the misfire (peak voltage comparison value Vpc for determining a misfire) is determined in advance by calibration. Then, if the end-of-discharge peak voltage Vp in the detection spark discharge is smaller than the peak voltage comparison value Vpc, it is determined that the misfire has occurred. On the other hand, if the end-of-discharge peak voltage Vp in the detection spark discharge is equal to or greater than the peak voltage comparison value Vpc, it is determined that the normal combustion has occurred.

Further, the lower limit value of the discharge period Td at the time of a misfire (discharge period comparison value Tdc for determining the misfire) is determined in advance by means of calibration. Then, if the discharge period Td of the detection spark discharge is greater than the discharge period comparison value Tdc, it is determined that a misfire has occurred. On the other hand, if the discharge period Td of the detection spark discharge is less than or equal to the discharge period comparison value Tdc, it is determined that the normal combustion has occurred. Note that the configuration of detecting a misfire from the discharge period Td will be described in a second embodiment to be described later.

### [Configurations of Peak Voltage Acquisition Unit and Determination Unit]

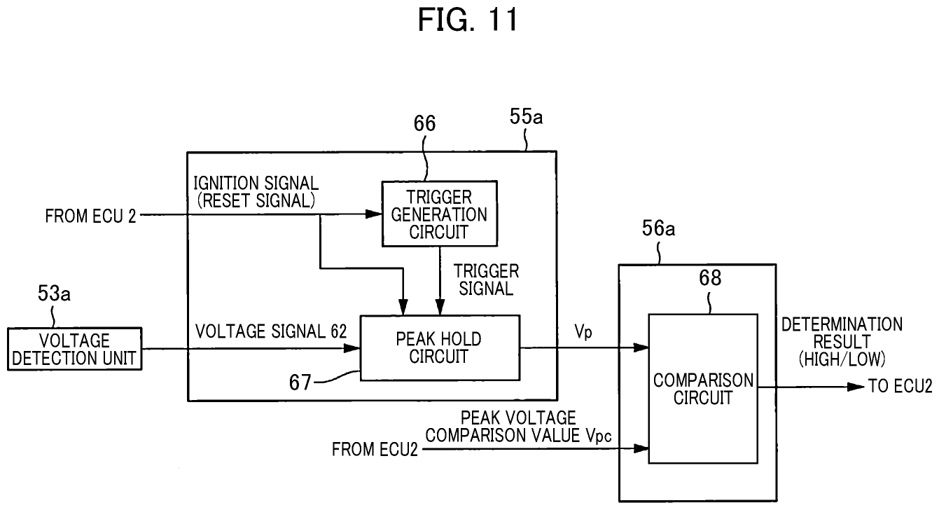

Next, the configurations of the peak voltage acquisition unit 55a and the determination unit 56a will be described using FIG. 11.

FIG. 11 is an explanatory diagram showing a configuration example of the peak voltage acquisition unit 55a and the determination unit 56a according to the first embodiment.

As shown in FIG. 11, the peak voltage acquisition unit 55a includes a trigger generation circuit 66 and a peak hold circuit 67. An ignition signal (reset signal) sent from the ECU 2 is input to the trigger generation circuit 66. Further, a trigger signal generated by the trigger generation circuit 66, the voltage signal 62 sent from the voltage detection unit 53a, and the ignition signal (reset signal) sent from the ECU 2 are input to the peak hold circuit 67.

Further, the determination unit 56a has a comparison circuit 68. The end-of-discharge peak voltage Vp output from the peak hold circuit 67 and the peak voltage comparison value Vpc sent from the ECU 2 are input to the comparison circuit 68. A determination result (High/Low) output from the comparison circuit 68 is sent to the ECU 2.

### [Operation of Peak Voltage Acquisition Unit and Determination Unit]

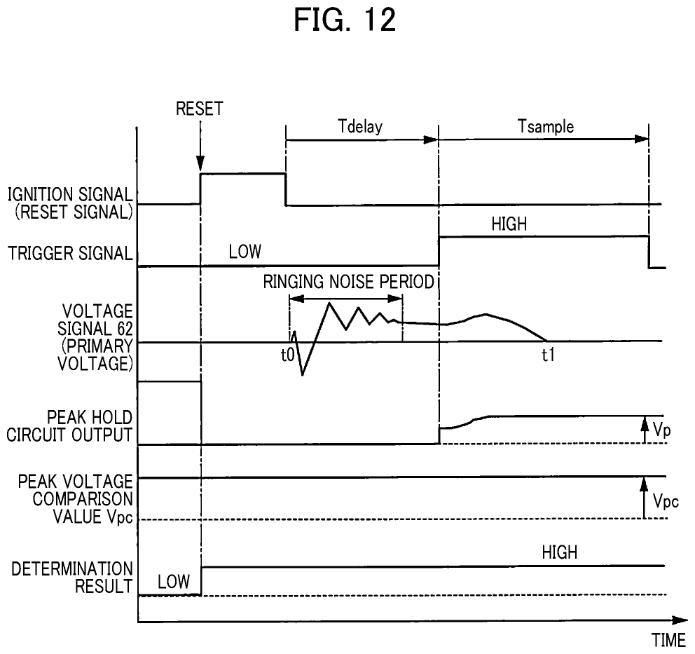

Next, a description will be made about an example of the operation of the peak voltage acquisition unit 55a and the determination unit 56a using FIG. 12.

FIG. 12 is an explanatory diagram showing an example of the operation of the peak voltage acquisition unit 55a and the determination unit 56a according to the first embodiment.

The horizontal axis in the graph of FIG. 12 indicates the passage of time. The graph in FIG. 12 shows, from the top, an ignition signal (reset signal) sent from the ECU 2, a trigger signal generated by the trigger generation circuit 66, a voltage signal 62 (primary voltage) sent from the voltage detection unit 53a, an output value of the peak hold circuit 67, a peak voltage comparison value Vpc sent from the ECU 2, and a determination result output by the comparison circuit 68.

As shown in FIG. 12, the trigger generation circuit 66 raises the trigger signal from Low to High after a Tdelay time has elapsed from the fall of the ignition signal (reset signal) from ON to OFF, and maintains the state of High until a Tsample period elapses. The peak hold circuit 67 holds the maximum value of the input voltage signal 62 during the High period of the trigger signal, and outputs the maximum value to the comparison circuit 68.

The Tdelay time is predetermined to be approximately ⅔ of the discharge period Td of the detection spark discharge. Further, the Tsample period is predetermined to be approximately the same as the discharge period Td of the detection spark discharge. By determining the Tdelay time and the Tsample period in this way, the peak hold circuit 67 can obtain the end-of-discharge peak voltage Vp in the detection spark discharge while avoiding the influence of ringing noise on the voltage signal 62.

The comparison circuit 68 compares the end-of-discharge peak voltage Vp acquired by the peak hold circuit 67 with the peak voltage comparison value Vpc. Then, when the end-of-discharge peak voltage Vp is smaller than the peak voltage comparison value Vpc, High (indicative of a misfire) is output. On the other hand, when the end-of-discharge peak voltage Vp is equal to or greater than the peak voltage comparison value Vpc, Low (indicative of normal combustion) is output. The output of the comparison circuit 68 is sent to the ECU 2 as the determination result in the determination unit 56a.

### [Procedure for Misfire Detection Based on Peak Voltage Using ECU Software]

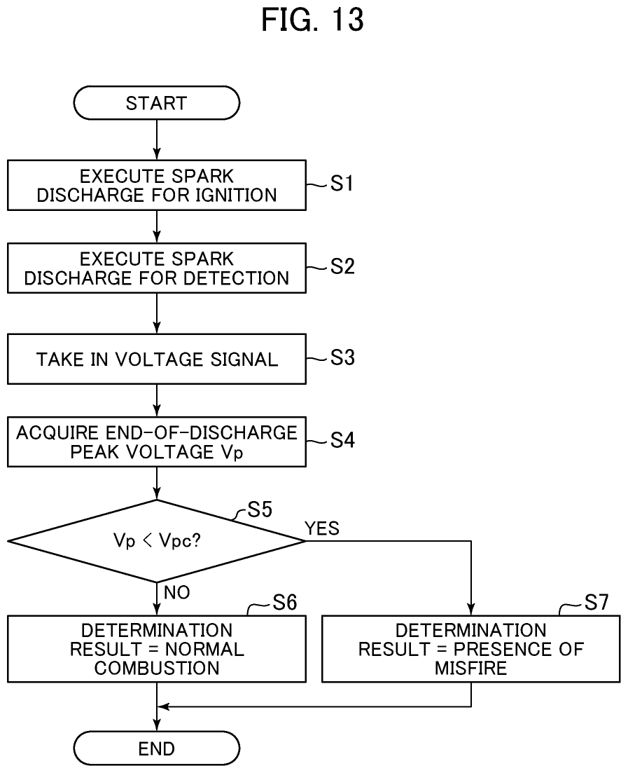

Next, a procedure for performing misfire detection based on the end-of-discharge peak voltage Vp by software of the ECU 2 will be described using FIG. 13.

FIG. 13 is a flowchart showing misfire detection processing based on the end-of-discharge peak voltage Vp by software of the ECU 2 according to the first embodiment.

In the combustion detection unit 1b shown in FIG. 5, the peak voltage acquisition unit 55b and the determination unit 56b are arranged inside the ECU 2. Therefore, the acquisition of the peak voltage and the misfire determination are executed by software running in the ECU 2.

As shown in FIG. 13, the ECU 2 sends an ignition signal to the igniter 54 in the ignition unit 51 from the latter half of the compression stroke to the early stage of the expansion stroke to execute a spark discharge for ignition (S1). Next, in the expansion stroke, the ECU 2 sends an ignition signal to the igniter 54 in the ignition unit 51 to execute a spark discharge for detection (S2). Next, the ECU 2 takes in the voltage signal 62 in the detection spark discharge detected by the voltage detection unit 53a of the combustion detection unit 1b (S3).

Next, the peak voltage acquisition unit 55b of the ECU 2 acquires the end-of-discharge peak voltage Vp from the voltage signal 62 (S4). Next, the determination unit 56b of the ECU 2 determines whether or not the end-of-discharge peak voltage Vp is smaller than the predetermined peak voltage comparison value Vpc (S5). When it is determined in Step S5 that the end-of-discharge peak voltage Vp is not smaller than the peak voltage comparison value Vpc (NO determination in S5), the determination unit 56b of the ECU 2 determines that the combustion is normal (S6). After the processing of Step S6, the ECU 2 ends misfire detection processing.

On the other hand, when it is determined in Step S5 that the end-of-discharge peak voltage Vp is smaller than the peak voltage comparison value Vpc (YES in S5), the determination unit 56b of the ECU 2 determines that there is a misfire (S7). After the processing of Step S7, the ECU 2 ends the misfire detection processing.

### Second Embodiment

### [Configurations of Ignition Unit and Combustion Detection Unit]

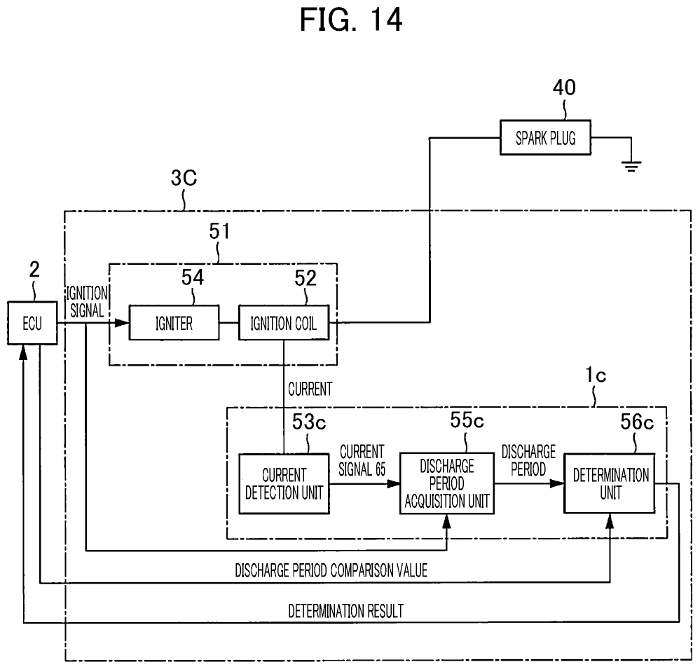

Next, the configurations of an ignition unit and a combustion detection unit according to a second embodiment will be described using FIG. 14.

FIG. 14 is an explanatory diagram showing a configuration example of an ignition unit and a combustion detection unit of an ignition device according to the second embodiment.

In the second embodiment, the combustion state is detected based on the discharge period Td in the detection spark discharge. As shown in FIG. 14, an ignition device 3C according to the second embodiment includes an ignition unit 51 and a combustion detection unit 1c. The combustion detection unit 1c corresponds to a combustion state detection device according to the present invention.

The ignition unit 51 includes an igniter 54 and an ignition coil 52. The igniter 54 receives an ignition signal sent from the ECU 2. The ignition coil 52 applies a high voltage to the spark plug 40.

The combustion detection unit 1c receives current information from the ignition unit 51 and determines the combustion state of the internal combustion engine 13 based on the current information. Then, the combustion detection unit 1c sends its determination result to the ECU 2. The combustion detection unit 1c includes a current detection unit 53c, a discharge period acquisition unit 55c, and a determination unit 56c.

The current detection unit 53c detects the secondary current of the ignition coil 52 and sends a current signal 65 (secondary current value) to the discharge period acquisition unit 55c. The discharge period acquisition unit 55c acquires the discharge period Td of the detection spark discharge. That is, the discharge period acquisition unit 55c acquires the discharge period of the ignition coil 52 based on the input current signal 65 and sends it to the determination unit 56c. The determination unit 56c determines a misfire in the internal combustion engine 13 based on the input discharge period and the discharge period comparison value received from the ECU 2, and sends its determination result to the ECU 2.

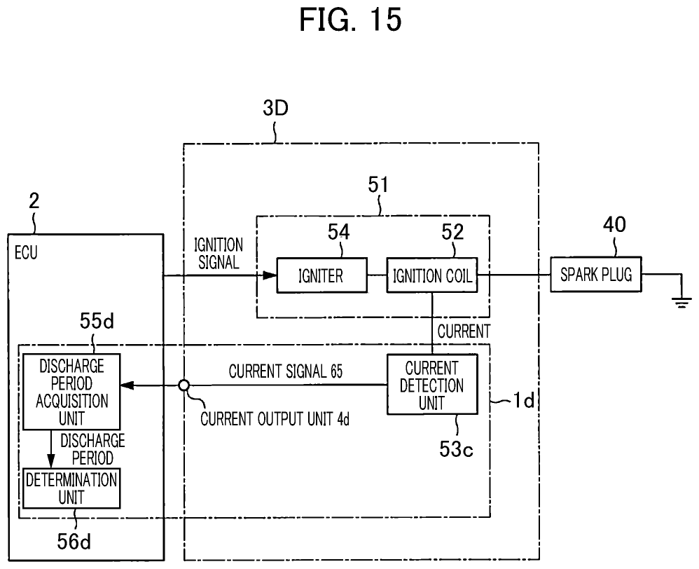

FIG. 14 shows an example in which all the component of the combustion detection unit 1c are arranged inside the ignition device 3C. However, some of the components of the combustion detection unit may be arranged inside the ECU 2. As shown in FIG. 15, an ignition device 3D includes an ignition unit 51 and a current detection unit 53c.

A combustion detection unit 1d is constituted of the current detection unit 53c arranged inside the ignition device 3D, and a discharge period acquisition unit 55d and a determination unit 56d arranged inside an ECU 2. The combustion detection unit 1d corresponds to a combustion state detection device according to the present invention.

A current signal 65 output from the current detection unit 53c is sent to the ECU 2 through a current output unit 4d. The current signal 65 output from the current detection unit 53c is a voltage value proportional to a detected coil current value. It is desirable that the current detection unit 58 adjusts the current signal 65 so that it falls within a predetermined voltage range (e.g., 0 to 5 volts) in such a manner that the current signal 65 can be easily handled in the ECU 2.

If the discharge period acquisition unit 55d and the determination unit 56d are arranged inside the ECU 2 as in the combustion detection unit 1d, the processing of the discharge period acquisition unit 55d and the determination unit 56d can be executed by software running on the ECU 2. In this case, for example, the conditions for misfire determination can be flexibly changed according to the operating state of the engine. Therefore, the detection of the combustion state (misfire determination) can be optimized.

### [Circuit Configurations of Ignition Unit and Current Detection Unit]

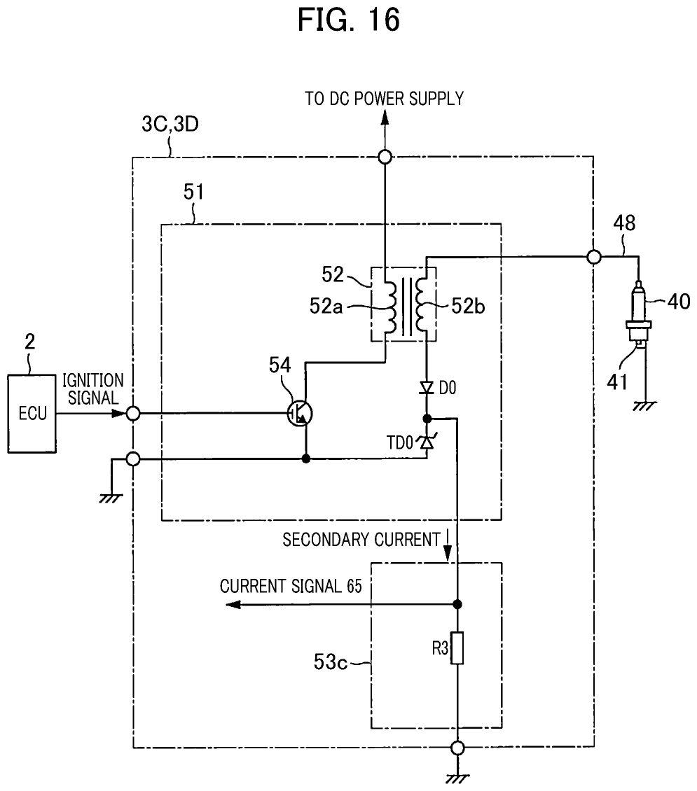

Next, the circuit configurations of the ignition unit 51 and the current detection unit 53c will be described using FIG. 16.

FIG. 16 is an explanatory diagram showing a circuit configuration example of the ignition unit 51 and the current detection unit 53c.

As shown in FIG. 16, the ignition unit 51 includes an ignition coil 52 and an igniter 54. Further, the current detection unit 53c has a current detection resistor R3.

In the ignition unit 51, one end of a primary coil 52a of the ignition coil 52 is connected to an unillustrated battery (DC power supply). Thus, a predetermined voltage (e.g., 12V) is applied to the primary coil 52a, so that a primary current flows. The other end of the primary coil 52a is connected to a collector terminal of the igniter 54. The other end of the primary coil 52a is grounded via an emitter terminal of the igniter 54. A transistor, a field effect transistor (FET), or the like is used for the igniter 54. A base terminal of the igniter 54 is connected to the ECU 2.

A secondary coil 52b of the ignition coil 52 shares a magnetic circuit and magnetic flux with the primary coil 52a. The ratio of the number of turns of the secondary coil 52b to the primary coil 52a is set to about 100, for example. One end of the secondary coil 52b is connected to an electrode of a spark plug 40 through a high tension cord 48. The other end of the secondary coil 52b is connected to an anode of a diode DO. A cathode of a diode D0 is connected to one end of the current detection resistor R3 of the current detection unit 58 and a cathode of a Zener diode TD0. An anode of the Zener diode TD0 is grounded.

While the ignition signal is being sent from the ECU 2 to the base terminal of the igniter 54, i.e., while the ignition signal is turned on, the collector and emitter terminals of the igniter 54 are brought into a conductive state. Thus, the primary current is output from the collector terminal of the igniter 54 to the emitter terminal thereof via the primary coil 52a.

When the sending of the ignition signal from the ECU 2 to the base terminal of the igniter 54 stops, i.e., when the ignition signal is turned off, the primary current flowing through the igniter 54 is cut off. At this time, a magnetic field change occurs in the primary coil 52a, and a primary voltage is generated due to self-induction. Then, a high secondary voltage corresponding to the winding number ratio is generated in the secondary coil 52b due to mutual induction. Thus, a secondary voltage is applied to the spark plug 40, and a spark discharge occurs in the ignition gap 41 of the spark plug 40. Further, a secondary current generated by the secondary voltage induced in the secondary coil 52b flows to the ground via the diode D0 and the current detection resistor R3.

The current detection unit 53c sends out a potential difference between both ends of the current detection resistor R3 as a current signal 65. Assuming that the magnitude of the secondary current flowing through the secondary coil 52b is I2, the voltage Vt of the current signal 65 is calculated by a formula (2).

$$\begin{matrix}[ Formula 2 ] & \\ V t = I 2 \times R 3 & ( 2 )\end{matrix}$$

That is, the current detection unit 53c sends a voltage value proportional to the magnitude of the secondary current to the discharge period acquisition units 55c and 55d as a current signal 65. Note that in order to facilitate handling of the current signal 65, the resistance value of the current detection resistor R3 is determined so that the current signal 65 is approximately 5 volts at maximum.

Further, the Zener diode TD0 of the ignition unit 51 forms a safety circuit at the time that the secondary current path is disconnected in the current detection unit 53c. To explain in more detail, when a path reaching the ground through the current detection resistor R3 of the current detection unit 53c is disconnected due to some reason, the voltage applied to the Zener diode TD0 increases. Then, when the applied voltage of the Zener diode TD0 becomes equal to or higher than the breakdown voltage of the Zener diode TD0, the secondary current flows to the ground through the Zener diode TD0. This ensures that the ignition coil 52 is discharged even when the secondary current path is disconnected in the current detection unit 53c.

### [Configurations of Discharge Period Acquisition Unit and Determination Unit]

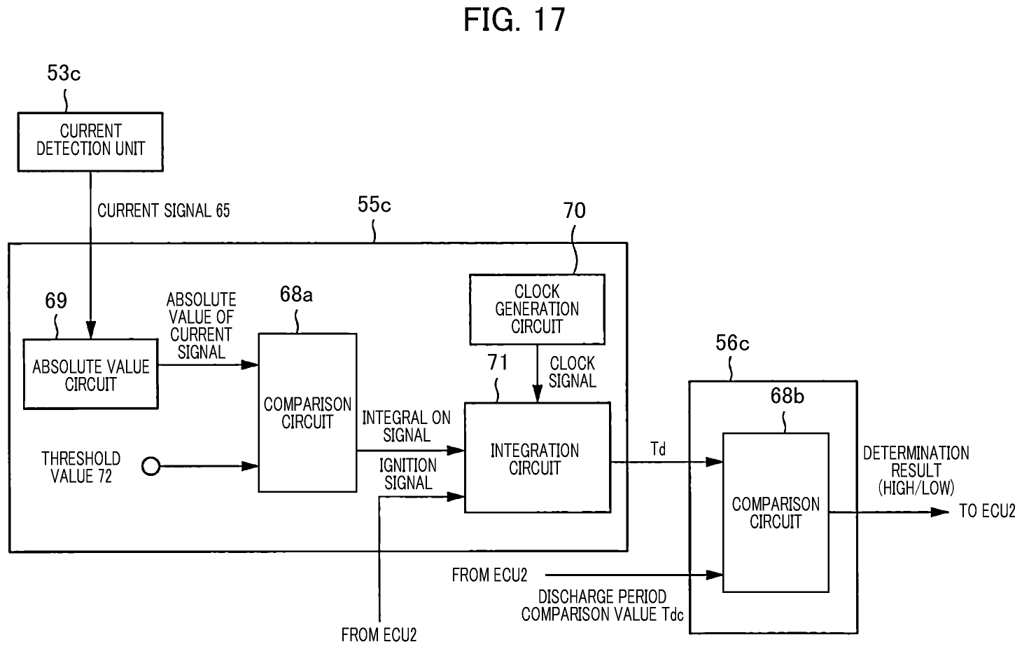

Next, the configurations of the discharge period acquisition unit 55c and the determination unit 56c will be described using FIG. 17.

FIG. 17 is an explanatory diagram showing a configuration example of the discharge period acquisition unit 55c and the determination unit 56c according to the second embodiment.

As shown in FIG. 17, the discharge period acquisition unit 55c includes an absolute value circuit 69, a comparison circuit 68a, a clock generation circuit 70, and an integration circuit 71. Further, the determination unit 56c has a comparison circuit 68b.

A current signal 65 sent from the current detection unit 55c is input to the absolute value circuit 69. The absolute value of the current signal 65 sent from the absolute value circuit 69 and a threshold value 72 are input to the comparison circuit 68a. The integration circuit 71 is inputted with an integral ON signal sent from the comparison circuit 68a, a clock signal (for example, a clock signal of 100 kHz) sent from the clock generation circuit 70, and an ignition signal sent from the ECU 2.

The comparison circuit 68b of the determination unit 56c is inputted with the discharge period Td sent from the integration circuit 71 and the discharge period comparison value Tdc sent from the ECU 2. The comparison circuit 68b outputs a determination result (High/Low). The determination result (High/Low) output from the comparison circuit 68b is sent to the ECU 2.

### [Operation of Discharge Period Acquisition Unit and Determination Unit]

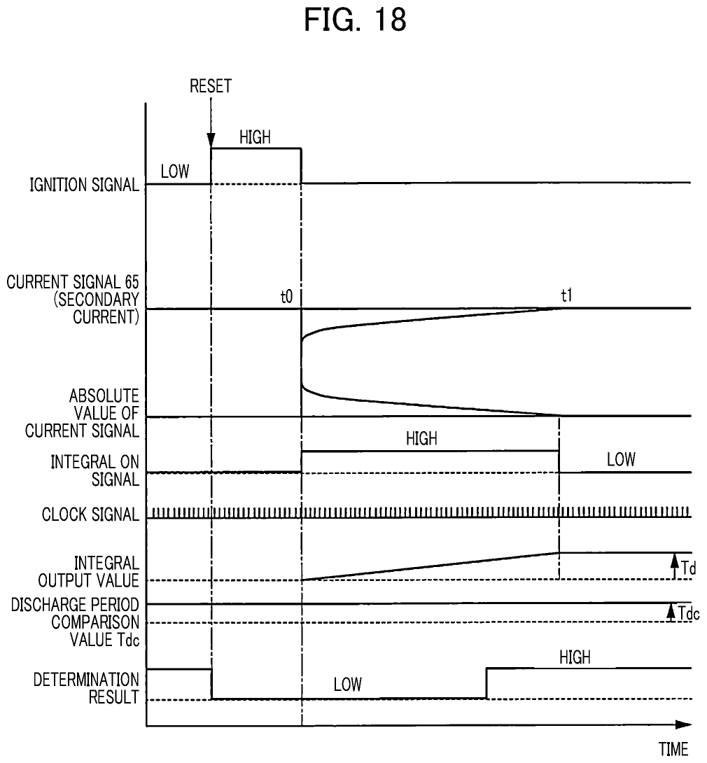

Next, a description will be made about an example of the operations of the discharge period acquisition unit 55c and the determination unit 56c using FIG. 18.

FIG. 18 is an explanatory diagram showing an example of the operations of the discharge period acquisition unit 55c and the determination unit 56c according to the second embodiment.

The horizontal axis of the graph in FIG. 18 indicates the passage of time. Further, the graph in FIG. 18 shows, from the top, an ignition signal sent from the ECU 2, a current signal 65 (secondary current) sent from the current detection unit 53c, the absolute value of the current signal sent from the absolute value circuit 69, an integral ON signal sent from the comparison circuit 68a, a clock signal sent from the clock generation circuit 70, an integral output value of the integration circuit 71, a discharge period comparison value Tdc sent from the ECU 2, and a determination result output by the comparison circuit 68b.

As shown in FIG. 18, the integration circuit 71 resets the output value to zero at the timing when ignition signal rises from Low to High. The absolute value circuit 69 convers the input current signal 65 into an absolute value and inputs it to the comparison circuit 68a as the absolute value of the current signal.

The comparison circuit 68a compares the absolute value of the input current signal with a threshold value 72 (refer to FIG. 17). When the absolute value of the current signal is larger than the threshold value 72, the comparison circuit 68a outputs an integral ON signal of High (indicative of an energizing state). Further, when the absolute value of the current signal is less than or equal to the threshold value 72, the comparison circuit 68a outputs an integral ON signal of Low (indicative of a non-energizing state).

The threshold value 72 is a value for determining the energization period of the secondary current. The threshold value 72 is defined in advance as a value which is sufficiently smaller than the average value of the current signal 65 during energization, and larger than the fluctuation width of the current signal 65 due to noise during non-energization. The threshold value 72 is, for example, the average value of the current signal 65 during energization×0.01.

The integration circuit 71 counts the number of clock signals input from the clock generation circuit 70 during a period in which the integral ON signal input from the comparison circuit 68a is High. Then, the integration circuit 71 outputs an integral output value calculated by the number of clocks/clock frequency. Since the period in which the integral ON signal is High is a current energizing time, i.e., the discharge period Td, the integral output value after the integral ON signal falls from High to Low is equal to the discharge period Td.

The comparison circuit 68b compares the discharge period Td obtained by the integration circuit 71 with the discharge period comparison value Tdc. Then, when the discharge period Td is greater than the discharge period comparison value Tdc, the comparison circuit 68b outputs High (indicating a misfire). On the other hand, when the discharge period Td is less than or equal to the discharge period comparison value Tdc, the comparison circuit 68b outputs Low (indicating normal combustion). The output of the comparison circuit 68b is sent to the ECU 2 as a determination result in the determination unit 56c.

### [Procedure for Misfire Detection Based on Discharge Period by Software of ECU]

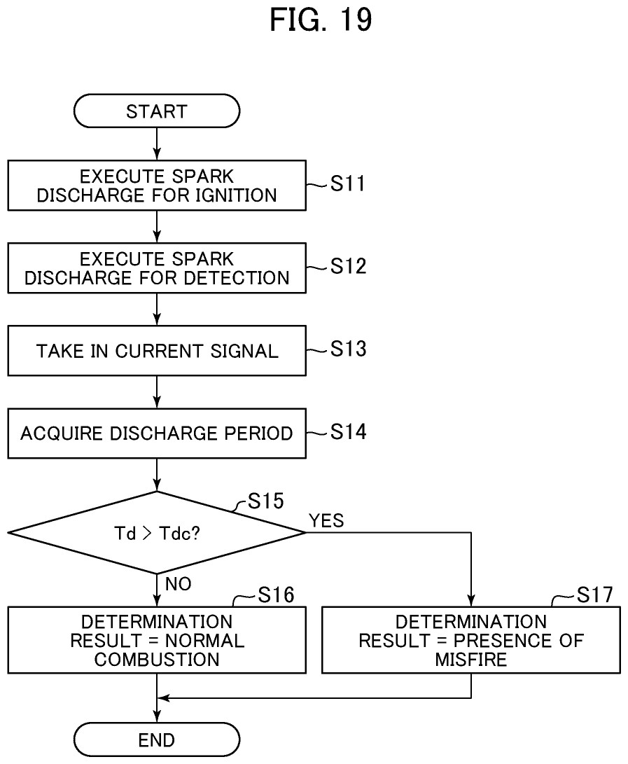

Next, a procedure for detecting a misfire based on the discharge period Td by software of the ECU 2 will be described using FIG. 19.

FIG. 19 is a flowchart showing a procedure for misfire detection based on the discharge period Td by software of the ECU 2 according to the second embodiment.

In the combustion detection unit 1d shown in FIG. 15, the discharge period acquisition unit 55d and the determination unit 56d are arranged inside the ECU 2. Therefore, the acquisition of the discharge period Td and the misfire determination are executed by software running on the ECU 2.

As shown in FIG. 19, the ECU 2 sends an ignition signal to the igniter 54 in the ignition unit 51 from the latter half of the compression stroke to the early state of the expansion stroke to execute a spark discharge for ignition (S11). Next, in the expansion stroke, the ECU 2 sends an ignition signal to the igniter 54 in the ignition unit 51 to execute a spark discharge for detection (S12). Next, the ECU 2 takes in the current signal 65 in the detection spark discharge detected by the current detection unit 53c of the combustion detection unit 1d (S13).

Next, the discharge period acquisition unit 55d of the ECU 2 acquires the discharge period Td from the current signal 65 (S14). Specifically, after the timing at which the ignition signal falls from High to Low, the time during which the absolute value of the current signal 65 becomes larger that a predetermined threshold value is acquired as the discharge period Td. Next, the determination unit 56d of the ECU 2 determines whether the discharge period Td is larger than a predetermined discharge period comparison value Tdc (S15). When it is determined in Step S15 that the discharge period Td is not larger than the discharge period comparison value Tdc (NO in S15), the determination unit 56d of the ECU 2 determines that the combustion is normal (S16). After the processing of Step S16, the ECU 2 ends the misfire detection processing.

On the other hand, when it is determined in Step S15 that the discharge period Td is larger than the discharge period comparison value Tdc (YES in S15), the determination unit 56d of the ECU 2 determines that there is a misfire (S17). After the processing of Step S17, the ECU 2 ends the misfire detection processing.

### Third Embodiment

### [Configurations of Ignition Unit and Combustion Detection Unit]

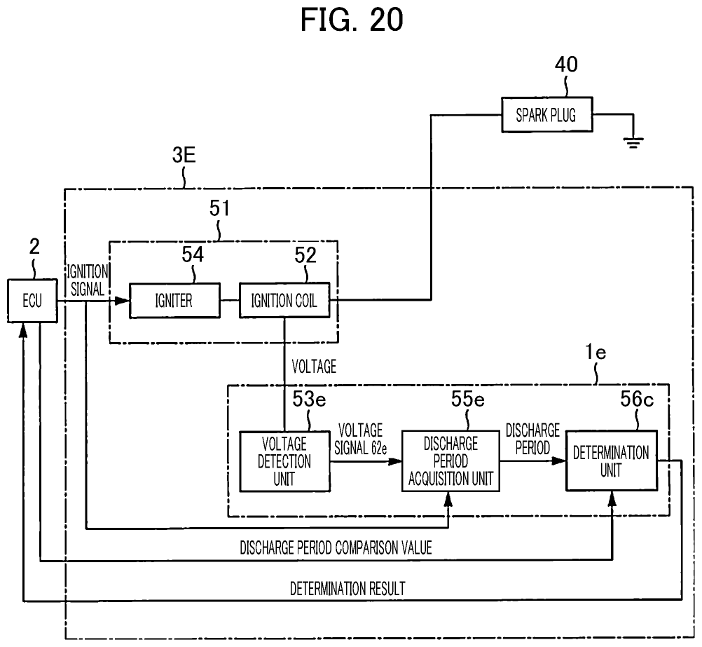

Next, the configurations of an ignition unit and a combustion detection unit according to a third embodiment will be described using FIG. 20.

FIG. 20 is an explanatory diagram showing a configuration example of an ignition unit and a combustion detection unit of an ignition device according to the third embodiment.

In the third embodiment, the combustion state is detected based on the discharge period Td in the detection spark discharge. As shown in FIG. 20, the ignition device 3E according to the third embodiment includes an ignition unit 51 and a combustion detection unit 1e. The combustion detection unit 1e corresponds to a combustion state detection device according to the present invention.

The ignition unit 51 includes an igniter 54 and an ignition coil 52. The igniter 54 receives an ignition signal sent from the ECU 2. The ignition coil 52 applies a high voltage to the spark plug 40.

The combustion detection unit 1e receives voltage information from the ignition unit 51 and determines the combustion state of the internal combustion engine 13 based on the voltage information. Then, the combustion detection unit 1e sends its determination result to the ECU 2. The combustion detection unit 1e includes a voltage detection unit 53e, a discharge period acquisition unit 55e, and a determination unit 56c.

The voltage detection unit 53e detects the primary voltage of an ignition coil 52 and sends a voltage signal 62e to the discharge period acquisition unit 55e. The discharge period acquisition unit 55e acquires the discharge period Td in the detection spark discharge. That is, the discharge period acquisition unit 55e acquires the discharge period of the ignition coil 52 based on the input voltage signal 62e and sends it to the determination unit 56c. The determination unit 56c determines a misfire in the internal combustion engine 13 based on the input discharge period and the discharge period comparison value received from the ECU 2, and sends its determination result to the ECU 2.

Note that the reason why the voltage detection unit 53e detects the primary voltage of the ignition coil 52 is to easily detect the discharge period of the ignition coil 52. The secondary voltage of the ignition coil 52 becomes an open voltage value after the completion of discharge of the ignition coil 52, and is maintained at a relatively high negative voltage value (e.g., −500V). Therefore, it is difficult to detect the discharge end timing of the ignition coil 52 from the magnitude of the secondary voltage of the ignition coil 52. On the other hand, the primary voltage of the ignition coil 52 becomes a reference voltage (approximately 0V) after the ignition coil 52 finishes discharging. Therefore, it is possible to easily detect the discharge end timing of the ignition coil 52 from the magnitude of the primary voltage of the ignition coil 52.

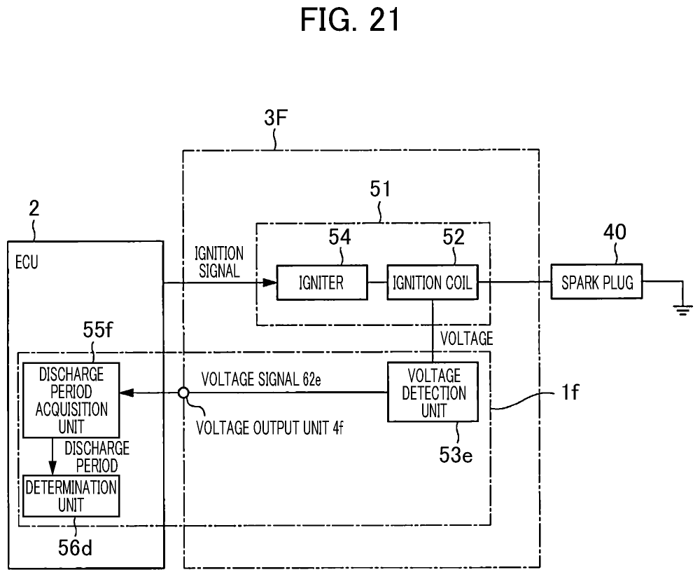

FIG. 20 shows an example in which all the components of the combustion detection unit 1e are arranged inside the ignition device 3E. However, some of the components of the combustion detection unit may be arranged inside the ECU 2. As shown in FIG. 21, an ignition device 3F includes an ignition unit 51 and a voltage detection unit 53e.

A combustion detection unit 1f is comprised of a voltage detection unit 53e arranged inside the ignition device 3F, and a discharge period acquisition unit 55f and a determination unit 56d arranged inside an ECU 2. The combustion detection unit 1f corresponds to a combustion state detection device according to the present invention.

The voltage signal 62e output from the voltage detection unit 53e is sent to the ECU 2 via the voltage output unit 4f. The voltage signal 62e output from the voltage detection unit 53e is a voltage value proportional to the detected coil voltage value. The voltage detection unit 53e adjusts the voltage signal 62e to a predetermined voltage range (e.g., 0 to 5 volts) so that the ECU 2 can easily handle the voltage signal 62e.

When the discharge period acquisition unit 55f and the determination unit 56d are arranged inside the ECU 2 as in the combustion detection unit 1f, the processing of the discharge period acquisition unit 55f and the determination unit 56d can be carried out by software running on the ECU 2. In this case, for example, the conditions for misfire determination can be flexibly changed according to the operating state of the engine. Therefore, the detection of the combustion state (misfire determination) can be optimized.

### [Configurations of Discharge Period Acquisition Unit and Determination Unit]

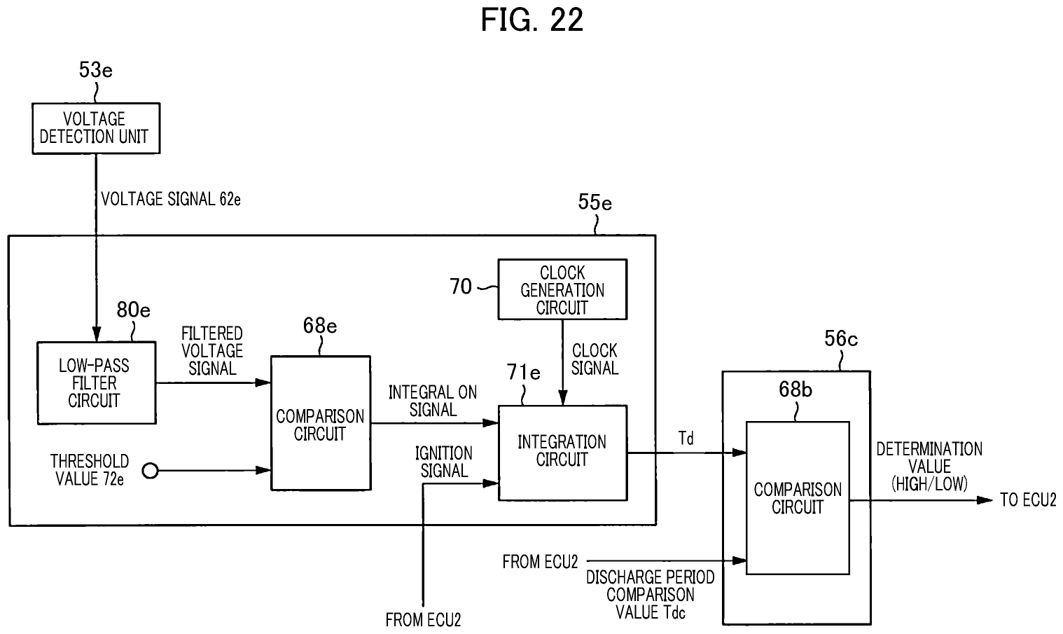

Next, the configurations of the discharge period acquisition unit 55e and the determination unit 56c will be described using FIG. 22.

FIG. 22 is an explanatory diagram showing a configuration example of the discharge period acquisition unit 55e and the determination unit 56c according to the third embodiment.

As shown in FIG. 22, the discharge period acquisition unit 55e includes a low-pass filter circuit 80e, a comparison circuit 68e, a clock generation circuit 70, and an integration circuit 71e. Further, the determination unit 56c has a comparison circuit 68b.

A voltage signal 62e sent from the voltage detection unit 53e is input to the low-pass filter circuit 80e. A cutoff period is set in the low-pass filter circuit 80e so that ringing noise in the voltage signal 62e is removed. The cutoff period of the low-pass filter circuit 80e is set to, for example, the detection spark discharge period Td×0.1.

The comparison circuit 68e is inputted with a filtered voltage signal sent from the low-pass filter circuit 80e and a threshold value 72e.

The integration circuit 71e is inputted with an integral ON signal sent from the comparison circuit 68e, a clock signal (e.g., a clock signal of 100 kHz) sent from the clock generation circuit 70, and an ignition signal sent from the ECU 2.

The comparison circuit 68b of the determination unit 56c is inputted with a discharge period Td sent from the integration circuit 71e and a discharge period comparison value Tdc sent from the ECU 2. The comparison circuit 68b outputs a determination result (High/Low). The determination result (High/Low) output from the comparison circuit 68b is sent to the ECU 2.

### [Operation of Discharge Period Acquisition Unit and Determination Unit]

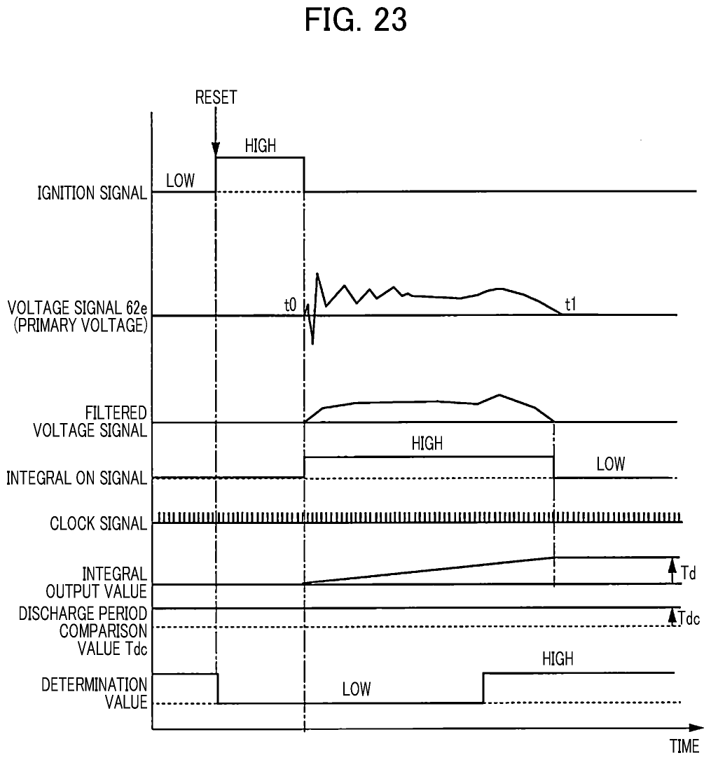

Next, a description will be made about an example of the operations of a discharge period acquisition unit 60e and the determination unit 56c using FIG. 23.

FIG. 23 is an explanatory diagram showing an example of the operations of the discharge period acquisition unit 55e and the determination unit 56c according to the third embodiment.

The horizontal axis of the graph in FIG. 23 indicates the passage of time. Further, the graph in FIG. 23 indicates, from the top, an ignition signal sent from the ECU 2, a voltage signal 62e (primary voltage) sent from the voltage detection unit 53e, a filtered voltage signal sent from the low-pass filter circuit 80e, an integral ON signal sent from the comparison circuit 68e, a clock signal sent from the clock generation circuit 70, an integral output value of the integration circuit 71e, a discharge period comparison value Tdc sent from the ECU 2, and a determination result output by the comparison circuit 68b.

As shown in FIG. 23, the integration circuit 71e resets the output value to zero at the timing at which the ignition signal rises from Low to High. The low-pass filter circuit 80e inputs the filtered voltage signal obtained by removing a high frequency component of the input voltage signal 62e to the comparison circuit 68e. The low-pass filter circuit 80e removes high frequency ringing noise caused in the voltage signal 62e. This can prevent erroneous detection of the discharge period obtained from the filtered voltage signal.

The comparison circuit 68e compares the input filtered voltage signal with the threshold value 72e (refer to FIG. 22). When the filtered voltage signal is larger than the threshold value 72e, the comparison circuit 68e outputs an integral ON signal of High (indicating an energizing state). Further, when the filtered voltage signal is equal to or less than the threshold value 72e, the comparison circuit 68e outputs an integral ON signal of Low (indicating a non-energizing state).

The threshold value 72e is a value for determining a current energizing period. The threshold value 72e is predetermined as a value sufficiently smaller than the average value of the voltage signal 62e during energization. The threshold value 72e is, for example, the average value of the voltage signal 62e during energization×0.01.

The integration circuit 71e counts the number of clock signals input from the clock generation circuit 70 during a period in which the integral ON signal input from the comparison circuit 68e is High. Then, the integration circuit 71e outputs an integral output value calculated by the number of clocks/clock frequency. The period during which the integral ON signal is High is the current energizing time, i.e., the discharge period Td. Therefore, the integral output value after the integral ON signal falls from High to Low is approximately equal to the discharge period Td.

The comparison circuit 68b compares the discharge period Td acquired by the integration circuit 71e with the discharge period comparison value Tdc. Then, when the discharge period Td is larger than the discharge period comparison value Tdc, the comparison circuit 68b outputs High (indicating a misfire). On the other hand, when the discharge period Td is equal to or less than the discharge period comparison value Tdc, the comparison circuit 68b outputs Low (indicating normal combustion). The output of the comparison circuit 68b is sent to the ECU 2 as a determination result in the determination unit 56c.

### [Procedure for Misfire Detection Based on Discharge Period by Software of ECU]

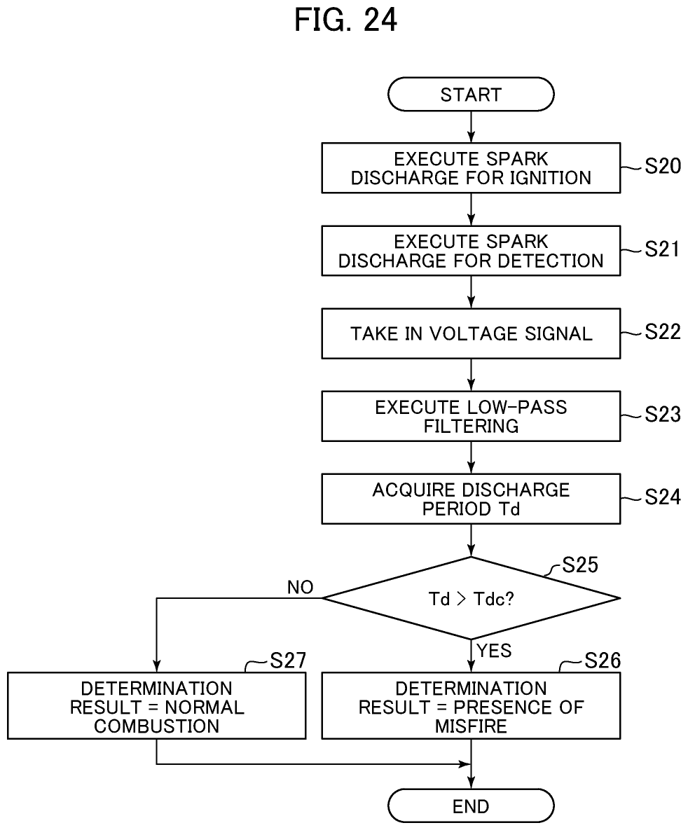

Next, a procedure for detecting the misfire based on the discharge period Td by software of the ECU 2 will be described using FIG. 24.

FIG. 24 is a flowchart showing the procedure for misfire detection processing based on the discharge period Td by software of the ECU 2 according to the third embodiment.

In the combustion detection unit 1f shown in FIG. 21, the discharge period acquisition unit 55f and the determination unit 56d are arranged inside the ECU 2. Therefore, the acquisition of the discharge period Td and the misfire determination are executed by software running on the ECU 2.

As shown in FIG. 24, the ECU 2 sends an ignition signal to the igniter 54 in the ignition unit 51 from the latter half of the compression stroke to the early stage of the expansion stroke to execute a spark discharge for ignition (S20). Next, the in the expansion stroke, the ECU 2 sends an ignition signal to the igniter 54 in the ignition unit 51 to execute a spark discharge for detection (S21). Next, the ECU 2 takes in the voltage signal 62e in the detection spark discharge detected by the voltage detection unit 53e of the combustion detection unit 1f (S22).

Next, the discharge period acquisition unit 55f of the ECU 2 removes high frequency components from the voltage signal 62e by low-pass filtering (S23). The low-pass filter of the discharge period acquisition unit 55f in the ECU 2 has a cutoff period set so that ringing noise of the voltage signal 62e is removed. The cutoff period is set to, for example, the detection spark discharge period Td×0.1. The reason why the discharge period acquisition unit 55f of the ECU 2 removes high frequency components by low-pass filtering is to remove high frequency ringing noise generated in the voltage signal 62e and prevent erroneous detection of the discharge period obtained thereafter.

Next, the discharge period acquisition unit 55f of the ECU 2 acquires the discharge period Td from the filtered voltage signal (S24). Specifically, the time during which the filtered voltage signal becomes larger than a predetermined energization determination threshold value after the timing at which the ignition signal falls from High to Low is acquired as the discharge period Td. The energization determination threshold value is a value for determining a current energizing period. The energization determination threshold value is predetermined as a value sufficiently smaller than the average value of the voltage signal 62 during energization. The energization determination threshold value is, for example, the average value of the voltage signal 62e during energization×0.01.

Next, the determination unit 56d of the ECU 2 determines whether or not the discharge period Td is larger than a predetermined discharge period comparison value Tdc (S25). When it is determined in Step S25 that the discharge period Td is not larger than the discharge period comparison value Tdc (NO in S25), the determination unit 56d of the ECU 2 determines that the combustion is normal (S27). After the processing of Step S27, the ECU 2 ends the misfire detection processing.

On the other hand, when it is determined in Step S25 that the discharge period Td is larger than the discharge period comparison value Tdc (YES in S25), the determination unit 56d of the ECU 2 determines that there is a misfire (S26). After the processing of Step S26, the ECU 2 ends the misfire detection processing.

### Fourth Embodiment

### [Configurations of Ignition Unit and Combustion Detection Unit]

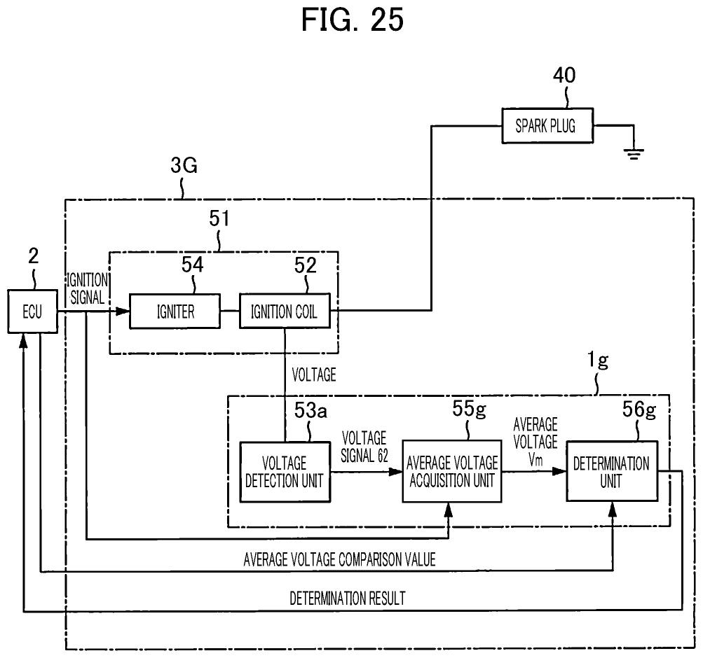

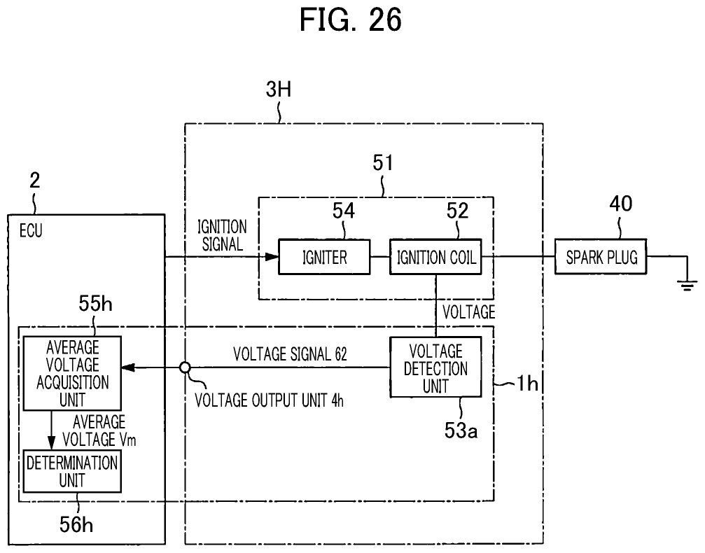

Next, the configurations of an ignition unit and a combustion detection unit of an ignition device according to a fourth embodiment of the present invention will be described using FIGS. 25 and 26.

FIG. 25 is an explanatory diagram showing a configuration example of an ignition unit 51 and a combustion detection unit 1g in an ignition device 3G according to the fourth embodiment. FIG. 26 is an explanatory diagram showing an example in which some of the components of the combustion detection unit according to the fourth embodiment are arranged inside an ECU 2.

As shown in FIG. 25, the ignition unit 51 includes an igniter 54 and an ignition coil 52. The igniter 54 receives an ignition signal sent from the ECU 2. The ignition coil 52 applies a high voltage to the spark plug 40.

The combustion detection unit 1g includes a voltage detection unit 53a, an average voltage acquisition unit 55g, and a determination unit 56g. The voltage detection unit 53a detects the voltage of the ignition coil 52 (primary voltage or secondary voltage with reversed polarity), and sends a voltage signal 62 to the average voltage acquisition unit 55g. Note that it is more desirable for the voltage detection unit 53a to detect the primary voltage of the ignition coil 52 than to detect the secondary voltage of the ignition coil 52.

The average voltage acquisition unit 55g acquires the average voltage value of the input voltage signal 62 and sends it to the determination unit 56g. The determination unit 56g performs misfire determination of the internal combustion engine 13 based on the input average voltage value and the average voltage comparison value received from the ECU 2, and sends its determination result to the ECU 2.

FIG. 25 shows an example in which all the components of the combustion detection unit 1g are arranged inside the ignition device 3G. However, some of the components of the combustion detection unit may be arranged inside the ECU 2. As shown in FIG. 26, an ignition device 3H includes an ignition unit 51 and a voltage detection unit 53a.

A combustion detection unit 1h is comprised of the voltage detection unit 53a arranged inside the ignition device 3H, and an average voltage acquisition unit 55h and a determination unit 56h arranged inside the ECU 2. The combustion detection unit 1h corresponds to a combustion state detection device according to the present invention. A voltage signal 62 output from the voltage detection unit 53a is sent to the ECU 2 through a voltage output unit 4h.

When the average voltage acquisition unit 55h and the determination unit 56h are arranged inside the ECU 2 as in the combustion detection unit 1h, the processing of the average voltage acquisition unit 55h and the determination unit 56h can be executed by software running on the ECU 2. In this case, for example, the conditions for misfire determination can be flexibly changed according to the operating state of the internal combustion engine 13. Therefore, the detection of the combustion state (misfire determination) can be optimized.

### [Averaging Period and Average Voltage]

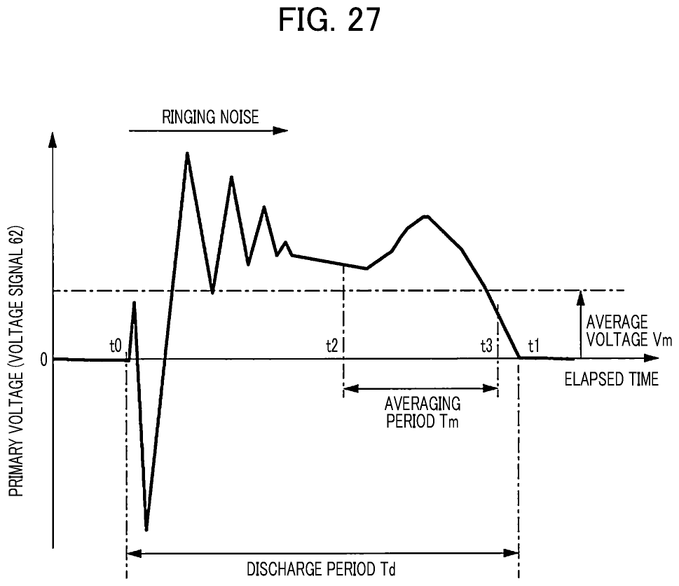

Next, the averaging period and average voltage of the primary voltage of the detection spark discharge according to the fourth embodiment will be described using FIG. 27.

FIG. 27 is an explanatory diagram of the average voltage acquired by the average voltage acquisition unit 55g or the average voltage acquisition unit 55h.

The horizontal axis of the graph shown in FIG. 27 indicates elapsed time. Further, the vertical axis of the graph shown in FIG. 27 indicates an example of the voltage signal 62 (primary voltage) in the detection spark discharge detected by the voltage detection unit 53a. Here, to indicates the timing provided to start the detection spark discharge, and t1 indicates the timing provided to end the detection spark discharge. Further, t2 indicates the timing at which the averaging of the voltage signal 62 is started, and t3 indicates the timing at which the averaging of the voltage signal 62 ends.

The average voltage acquisition unit 55g or the average voltage acquisition unit 55h acquires the average voltage Vm of the voltage signal 62 within the discharge period Td of the detection spark discharge. Here, the average voltage Vm is an ensemble average value of the voltage (primary voltage or polarity-inverted secondary voltage) within the discharge period Td. Further, the average voltage Vm may be an RMS value (square root of square mean value) of the voltage (primary voltage or secondary voltage) within the discharge period Td.

It is desirable that the period during which the voltage signal 62 is averaged (averaging period Tm) is within the discharge period Td of the detection spark discharge and at the latter half of the discharge period Td. More specifically, it is desirable that the averaging start timing t2 of the voltage signal 62 is after 50% of the discharge period Td. Further, it is desirable that the averaging end timing t3 of the voltage signal 62 is after 90% of the discharge period Td. According to the inventor's experiments, a desirable range of the averaging start timing t2 of the voltage signal 62 is expressed by a formula (3). Further, a desirable range of the averaging end timing t3 of the voltage signal 62 is expressed by a formula (4).

$$\begin{matrix}[ Formula 3 ] & \\ t 0 + 0 \text{.9} \times Td > t 2 \geq t 0 + 0.5 \times Td & ( 3 )\end{matrix}$$

$$\begin{matrix}[ Formula 4 ] & \\ t 0 + Td \geq t 3 \geq t 0 + 0 \text{.9} \times Td & ( 4 )\end{matrix}$$

The reason why it is desirable that the averaging start timing t2 of the voltage signal 62 is after 50% of the discharge period is because the voltage becomes unstable due to ringing noise in the first half of the detection spark discharge. The reason why it is desirable that the averaging end timing t3 of the voltage signal 62 is after 90% of the discharge period is because as described above, the voltage at the end of the detection spark discharge has a strong correlation with the in-cylinder pressure.

### [In-Cylinder Pressure and Average Voltage]

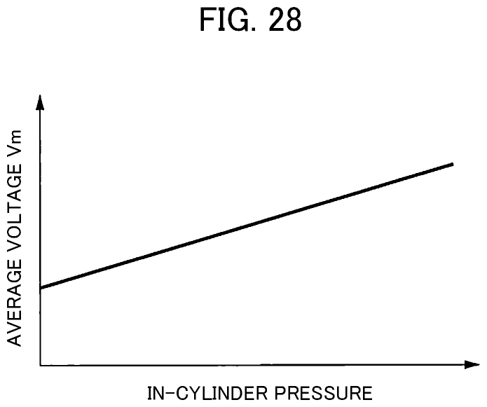

Next, the relationship between the in-cylinder pressure and the average voltage according to the fourth embodiment will be described using FIG. 28.

FIG. 28 is an explanatory diagram showing the relationship between the in-cylinder pressure and the average voltage Vm at the detection spark discharge timing.

As shown in FIG. 28, there is a strong correlation between the in-cylinder pressure and the average voltage Vm at the detection spark discharge timing. That is, the average voltage Vm becomes larger as the in-cylinder pressure rises at the detection spark discharge timing. When a misfire occurs, the in-cylinder pressure at the detection spark discharge timing becomes lower than during the normal combustion. Therefore, it is possible to discriminate between the misfire and the normal combustion based on the magnitude of the average voltage Vm.

### [Procedure for Misfire Detection Based on Average Voltage by Software of ECU]

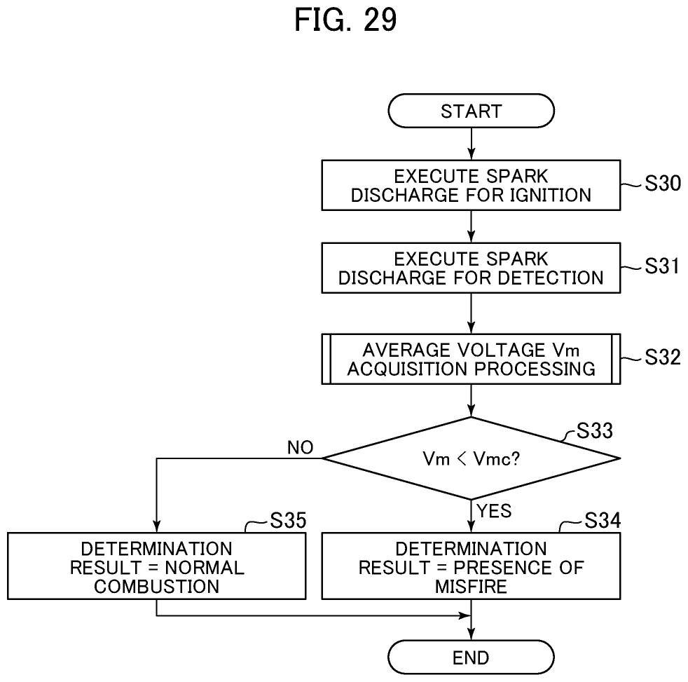

Next, a procedure for detecting a misfire based on the average voltage Vm by software of the ECU 2 according to the fourth embodiment will be described using FIG. 29.

FIG. 29 is a flowchart showing the procedure of misfire detection processing according to the fourth embodiment.

In the combustion detection unit 1h shown in FIG. 26, the average voltage acquisition unit 55h and the determination unit 56h are arranged inside the ECU 2. Therefore, the acquisition of the average voltage Vm and the misfire determination are executed by software running on the ECU 2.

As shown in FIG. 29, the ECU 2 sends an ignition signal to the igniter 54 in the ignition unit 51 from the latter half of the compression stroke to the early stage of the expansion stroke to execute a spark discharge for ignition (S30). Next, in the expansion stroke, the ECU 2 sends an ignition signal to the igniter 54 in the ignition unit 51 to execute a spark discharge for detection (S31). Next, the average voltage acquisition unit 55h of the ECU 2 performs average voltage Vm acquisition processing (S32). In Step S32, the average voltage acquisition unit 55h acquires the average voltage Vm from the voltage signal 62. Next, the determination unit 56h of the ECU 2 determines whether or not the average voltage Vm is smaller than a predetermined average voltage comparison value Vmc (S33).

In Step S33, when it is determined that the average voltage Vm is not smaller than the average voltage comparison value Vmc (NO in S33), the determination unit 56h of the ECU 2 determines that the combustion is normal (S35). After the processing of Step S35, the ECU 2 ends the misfire detection processing. On the other hand, when it is determined in Step S33 that the average voltage Vm is smaller than the average voltage comparison value Vmc (YES in S33), the determination unit 56h of the ECU 2 determines that there is a misfire (S34). After the processing of Step S34, the ECU 2 ends the misfire detection processing.

### [Average Voltage Vm Acquisition Processing]

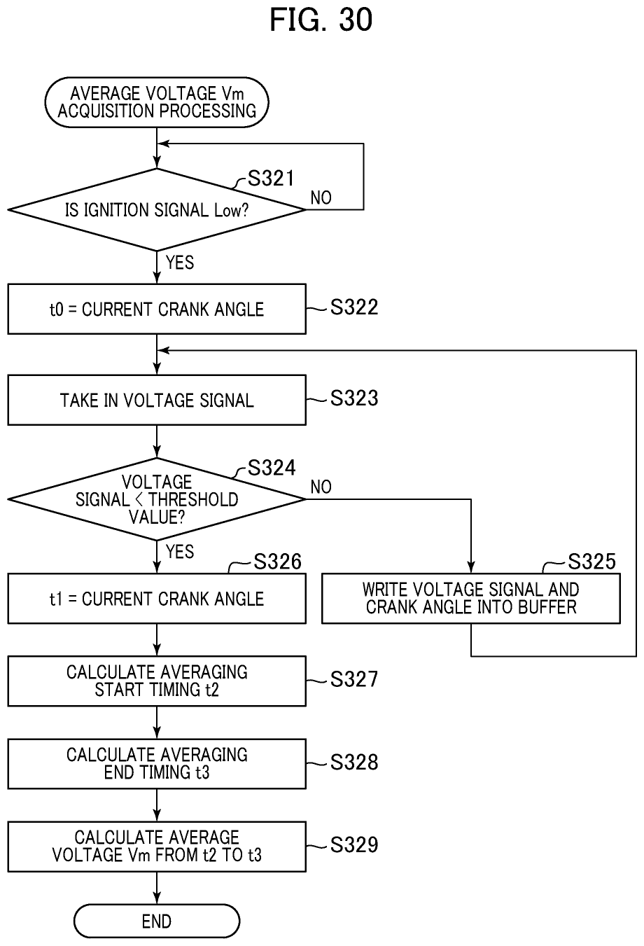

Next, the average voltage Vm acquisition processing executed in Step S32 in the misfire detection processing shown in FIG. 29 will be described using FIG. 30.

FIG. 30 is a flowchart showing a procedure for calculating the average voltage Vm by software of the ECU 2.

As shown in FIG. 30, the ECU 2 determines whether or not the ignition signal is Low (S321). In Step S321, when the ignition signal is not Low (NO in S321), the ECU 2 repeats Step S321. On the other hand, when the ignition signal is Low (YES in S321), the ECU 2 determines that the detection spark discharge has started, and sets the current crank angle to the discharge start timing to (S322).

Next, the ECU 2 takes in the voltage signal 62 in the detection spark discharge detected by the voltage detection unit 53a of the combustion detection unit 1h (S323). Then, the ECU 2 determines whether the voltage signal 62 is smaller than a predetermined energization determination threshold value (S324). In Step S324, when the voltage signal is not smaller than the predetermined energization determination threshold value (NO in S324), the ECU 2 writes the voltage signal and the current crank angle into a buffer (S325). After the processing of Step S325, the ECU 2 returns to Step S323.

In Step S324, when the voltage signal is smaller than the predetermined energization determination threshold value (YES in S324), the ECU 2 determines that the detection spark discharge has ended, and sets the current crank angle to the discharge end timing t1 (S326). The energization determination threshold value is a value for determining a current energizing period. The energization determination threshold value is predetermined as a value sufficiently smaller than the average value of the voltage signal 62 during energization. The energization determination threshold value is, for example, the average value of the voltage signal 62 during energization×0.01.

Next, the ECU 2 calculates the averaging start timing t2 of the voltage signal from the discharge start timing to and the discharge end timing t1 (S327). The averaging start timing t2 is calculated by the above-described formula (3), for example. Next, the ECU 2 calculates the averaging end timing t3 of the voltage signal from the discharge start timing to and the discharge end timing t1 (S328). The averaging end timing t3 is calculated by the above-described formula (4), for example.

Next, the ECU 2 calculates the average voltage Vm of the voltage signal from the averaging start timing t2 to the averaging end timing t3 based on the voltage signal value and crank angle written into the buffer in Step S325 (S329). The average voltage Vm is, for example, an ensemble average of the voltage signal 62 from the averaging start timing t2 to the averaging end timing t3. Further, the average voltage Vm is, for example, the RMS value of the voltage signal 62 from the averaging start timing t2 to the averaging end timing t3. After the processing of Step S329, the ECU 2 ends the average voltage Vm acquisition processing and executes Step S33 of the misfire detection processing shown in FIG. 29.

### Fifth Embodiment

### [Configurations of Ignition Unit and Combustion Detection Unit]

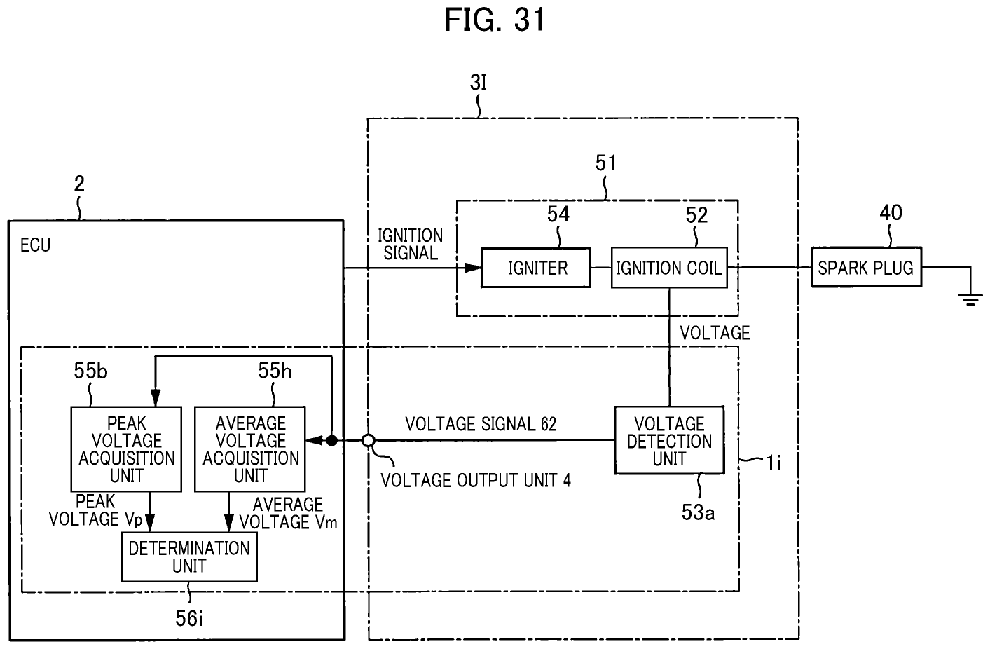

Next, the configurations of an ignition unit and a combustion detection unit of an ignition device according to a fifth embodiment of the present invention will be described using FIG. 31.

FIG. 31 is an explanatory diagram showing a configuration example of an ignition unit and a combustion detection unit according to the fifth embodiment.

As shown in FIG. 31, the ignition device 3I includes an ignition unit 51 and a voltage detection unit 53a. The ignition unit 51 includes an igniter 54 and an ignition coil 52. The igniter 54 receives an ignition signal sent from the ECU 2. The ignition coil 52 applies a high voltage to the spark plug 40.

The voltage detection unit 53a detects the voltage of the ignition coil 52 (primary voltage or secondary voltage with reversed polarity). Note that it is more desirable for the voltage detection unit 53a to detect the primary voltage of the ignition coil 52 than to detect the secondary voltage of the ignition coil 52.

A combustion detection unit 1i is comprised of a voltage detection unit 53a arranged inside the ignition device 3I, and a peak voltage acquisition unit 55b, an average voltage acquisition unit 55h, and a determination unit 56i arranged inside an ECU 2. The combustion detection unit 1i corresponds to a combustion state detection device according to the present invention.

The peak voltage acquisition unit 55b acquires a peak voltage Vp of an input voltage signal 62 and sends it to the determination unit 56i. The average voltage acquisition unit 55h acquires the average voltage Vm of the input voltage signal 62 and sends it to the determination unit 56i. The determination unit 56i determines whether the internal combustion engine 13 has misfired, based on the input peak voltage Vp or average voltage Vm and the average voltage comparison value or peak voltage comparison value determined in advance by the ECU 2.

### [Procedure for Misfire Detection by Software of ECU]

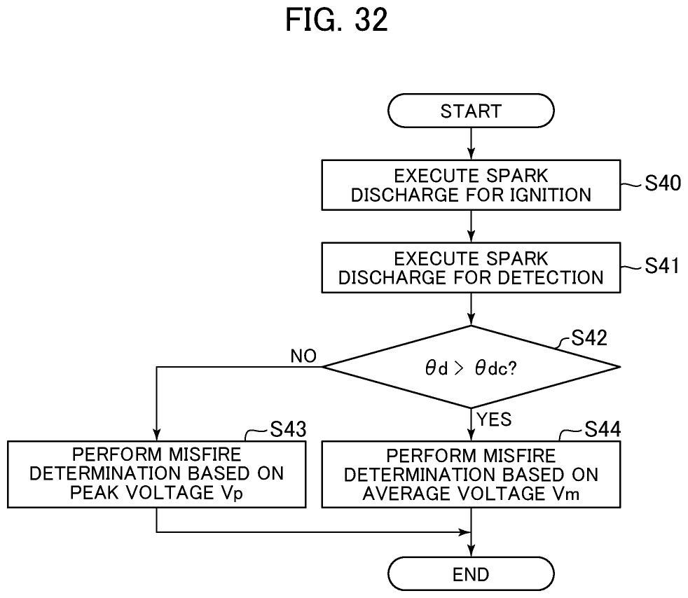

Next, a procedure for detecting a misfire by software of the ECU 2 according to the fifth embodiment will be described using FIG. 32.

FIG. 32 is a flowchart showing a procedure of misfire detection processing according to the fifth embodiment.

In the combustion detection unit 1i shown in FIG. 31, the peak voltage acquisition unit 55b, the average voltage acquisition unit 55h, and the determination unit 56i are arranged inside the ECU 2. Therefore, the acquisition of the peak voltage Vp, the acquisition of the average voltage Vm, and the misfire determination are executed by software running on the ECU 2.

As shown in FIG. 32, the ECU 2 sends an ignition signal to the igniter 54 in the ignition unit 51 from the latter half of the compression stroke to the early stage of the expansion stroke to execute a spark discharge for ignition (S40). Next, in the expansion stroke, the ECU 2 sends an ignition signal to the igniter 54 in the ignition unit 51 to execute a spark discharge for detection (S41). Next, the ECU 2 determines whether or not the detection spark discharge timing θd is larger than a predetermined timing comparison value θdc (S42).

In Step S42, when it is determined that the detection spark discharge timing θd is not larger than the predetermined timing comparison value θdc (NO in S42), the ECU 2 performs a misfire determination based on the peak voltage Vp (S43). More specifically, the misfire determination is executed according to the procedure from Step S3 onwards in the misfire determination processing based on the peak voltage Vp shown in FIG. 13. After the processing of Step S44, the ECU 2 ends the misfire detection processing.

In Step S42, when it is determined that the detection spark discharge timing θd is larger than the predetermined timing comparison value θdc (YES in S42), the ECU 2 performs a misfire determination based on the average voltage Vm (S44). More specifically, the misfire determination is executed according to the procedure from Step S32 onwards in the misfire determination processing based on the average voltage Vm shown in FIG. 29. After the processing of Step S44, the ECU 2 ends the misfire detection processing.

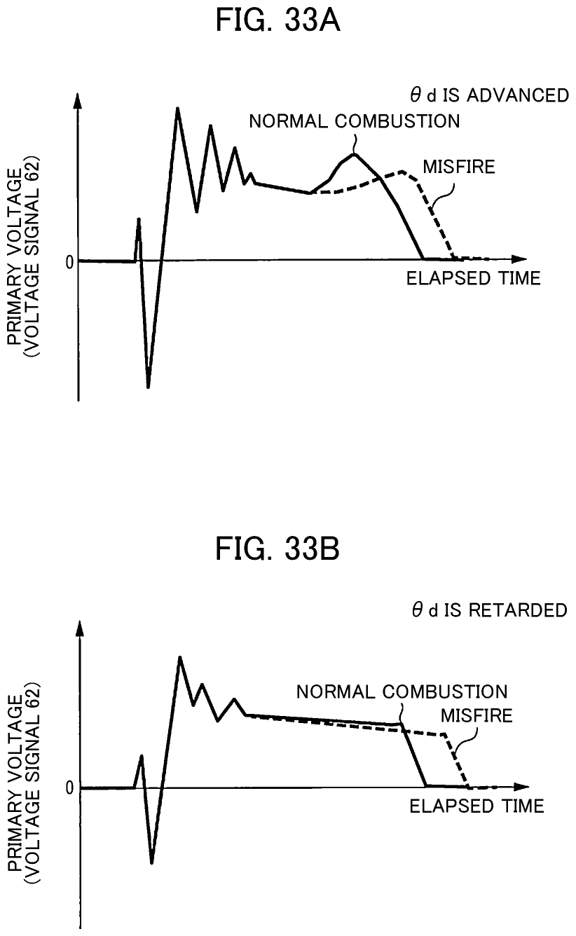

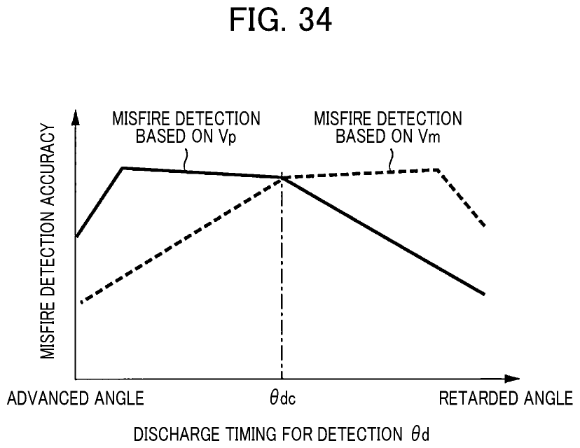

Thus, in the fifth embodiment, the misfire determination based on the peak voltage Vp and the misfire determination based on the average voltage Vm are switched according to the detection spark discharge timing θd. This advantage will be described using FIGS. 33A and 33B and FIG. 34.

FIGS. 33A and 33B are explanatory diagrams showing an example of the behavior of the primary (voltage signal 62) in the detection spark discharge when the detection spark discharge timing Od differs. FIG. 33A shows an example of the behavior of the primary voltage (voltage signal 62) when the detection spark discharge timing θd is advanced (for example, the detection spark discharge timing θd is 50° after compression top dead center). FIG. 33B shows an example of the behavior of the primary voltage (voltage signal 62) when the detection spark discharge timing θd is retarded (for example, the detection spark discharge timing θd is 90° after compression top dead center). Further, a solid line in each of FIGS. 33A and 33B indicates an example of the behavior of the primary voltage (voltage signal 62) during the normal combustion, and a dotted line indicates an example of the behavior of the primary voltage (voltage signal 62) during the misfire.

As shown in FIG. 33A, when the detection spark discharge timing θd is advanced (for example, the detection spark discharge timing θd is 30° after compression top dead center), the gas flow in the cylinder is relatively strong, and the elongation of the discharge path in the detection spark discharge increases. Thus, when the detection spark discharge timing θd is advanced, the behavior of voltage rising at the end of the detection spark discharge becomes remarkable. Therefore, when the detection spark discharge timing θd is advanced, the normal combustion and misfire can be easily distinguished based on the peak voltage Vp.

On the other hand, as shown in FIG. 33B, when the detection spark discharge timing θd is retarded (for example, the detection spark discharge timing θd is 90° after compression top dead center), the gas flow in the cylinder is relatively weak, and the elongation of the discharge path in the detection spark discharge becomes small. Consequently, when the detection spark discharge timing ed is retarded, a rise in the voltage at the end of the discharge becomes smaller than when the detection spark discharge timing ed is advanced. Therefore, when the detection spark discharge timing θd is retarded, it is possible to easily distinguish between the normal combustion and the misfire based on the average voltage Vm.

FIG. 34 is an explanatory diagram showing an example of misfire detection accuracy when the misfire detection based on the peak voltage Vp is performed with respect to a change in the detection spark discharge timing ed, and when the misfire detection based on the average voltage Vm is performed. The misfire detection accuracy is the ratio of the number of cycles in which the misfire and the normal combustion can be correctly determined with respect to the number of test cycles.

As shown in FIG. 34, when the detection spark discharge timing θd is advanced, the rise in the voltage at the end of the detection spark discharge is significant. Therefore, the misfire detection based on the peak voltage Vp shows a tendency of misfire detection accuracy higher than at the misfire detection based on the average voltage Vm. On the other hand, when the detection spark discharge timing θd is retarded, the voltage rise at the end of the detection spark discharge is small. Therefore, the misfire detection based on the average voltage Vm shows a tendency of misfire detection accuracy higher than at the misfire detection based on the peak voltage Vp.

The detection spark discharge timing ed is carried out after the ignition spark discharge timing. Therefore, the detection spark discharge timing θd depends on the ignition spark discharge timing. The ignition spark discharge timing variously changes depending on operating conditions such as the rotational speed and torque of the internal combustion engine, and the amount of exhaust gas recirculation (EGR). That is, the appropriate detection spark discharge timing θd variously changes depending on operating conditions such as the rotational speed and torque of the internal combustion engine, and the amount of exhaust gas recirculation (EGR).

Therefore, the determination unit 56i of the ECU 2 according to the fifth embodiment compares the detection spark discharge timing θd and the timing comparison value θdc. Then, when the detection spark discharge timing θd is not retarded than the timing comparison value θdc, the determination unit 56i of the ECU 2 performs misfire detection based on the peak voltage Vp. Further, when the detection spark discharge timing θd is retarded than the timing comparison value θdc, the determination unit 56i of the ECU 2 performs misfire detection based on the average voltage Vm. Consequently, the misfire determination processing according to the fifth embodiment can obtain high misfire detection accuracy even if the detection spark discharge timing θd changes.

Note that as the timing comparison value θdc, an appropriate value is determined in advance by calibration and the like so that sufficient misfire detection accuracy can be obtained at the detection spark discharge timing ed that switches between the misfire detection based on the peak voltage Vp and the misfire detection based on the average voltage. An appropriate value for the timing comparison value θdc is, for example, 70° after compression top dead center.

Further, the timing comparison value θdc does not necessarily have to be a constant value, and may be changed depending on the operating conditions of the internal combustion engine. For example, appropriate values for the timing comparison value θdc are stored in advance as map data with respect to changes in rotational speed and torque of the internal combustion engine, etc. Then, the determination unit 56i of the ECU 2 refers to the map data and changes the timing comparison value θdc according to the operating conditions of the internal combustion engine. By changing the timing comparison value θdc according to the operating conditions of the internal combustion engine in this way, it is possible to highly maintain misfire detection accuracy even if the operating conditions of the internal combustion engine change.

### Sixth Embodiment

### [Configurations of Ignition Unit and Combustion Detection Unit]

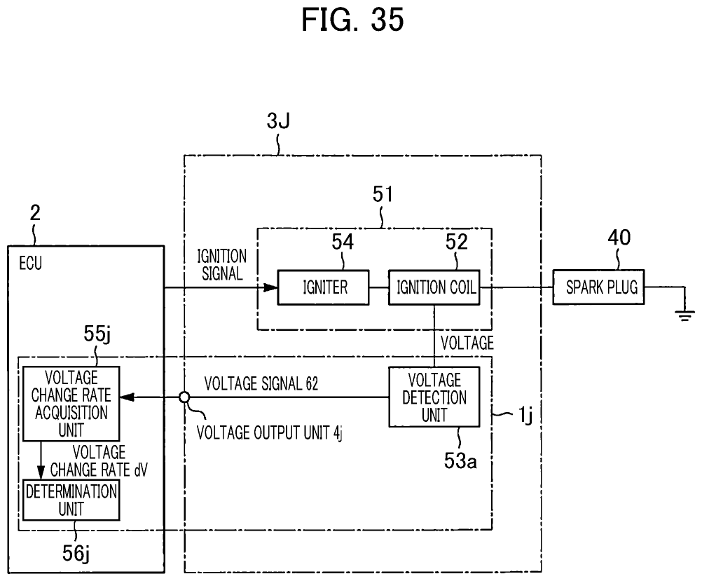

Next, the configurations of an ignition unit and a combustion detection unit of an ignition device according to a sixth embodiment of the present invention will be described using FIG. 35.

FIG. 35 is an explanatory diagram showing a configuration example of an ignition unit and a combustion detection unit according to the sixth embodiment.

As shown in FIG. 35, an ignition device 3J includes an ignition unit 51 and a voltage detection unit 53a.

The ignition unit 51 includes an igniter 54 and an ignition coil 52. The igniter 54 receives an ignition signal sent from the ECU 2. The ignition coil 52 applies a high voltage to the spark plug 40.

The voltage detection unit 53a detects the voltage of an ignition coil 52 (primary voltage or secondary voltage with reversed polarity). Note that it is more desirable for the voltage detection unit 53a to detect the primary voltage of the ignition coil 52 than to detect the secondary voltage of the ignition coil 52.

A combustion detection unit 1j is comprised of a voltage detection unit 53a arranged inside the ignition device 3J, and a voltage change rate acquisition unit 55j and a determination unit 56j arranged inside an ECU 2. The combustion detection unit 1j corresponds to a combustion state detection device according to the present invention. The voltage detection unit 53a detects the voltage of an ignition coil 52 (primary voltage or secondary voltage reversed in polarity) and outputs it as a voltage signal 62.

The voltage change rate acquisition unit 55j arranged inside the ECU 2 acquires a voltage change rate dV from the input voltage signal 62 and sends it to the determination unit 56j. The determination unit 56j determines whether the internal combustion engine 13 has misfired, based on the input voltage change rate dV and a voltage change rate comparison value predetermined by the ECU 2.

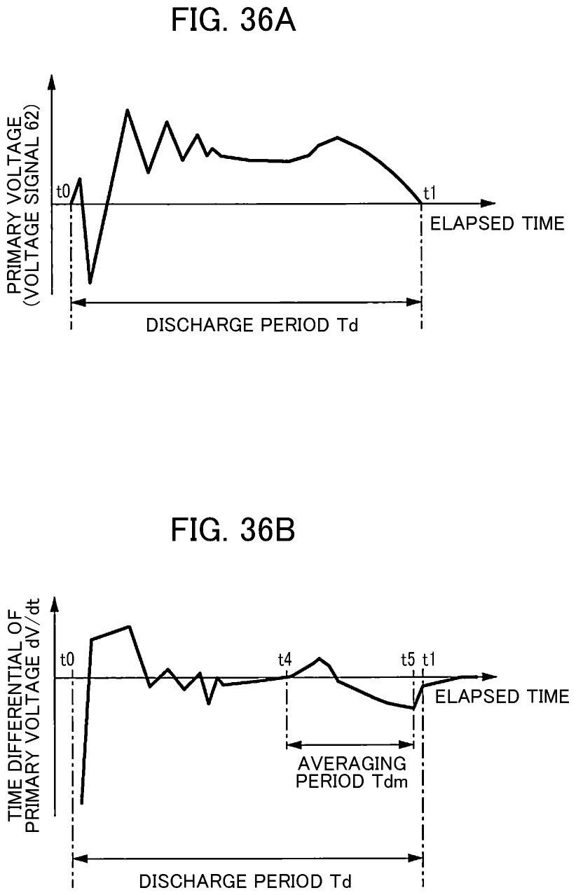

FIGS. 36A and 36B are explanatory diagrams of the voltage change rate acquired by the voltage change rate acquisition unit 55j. The horizontal axis of the graph shown in each of FIGS. 36A and 36B indicates elapsed time. The vertical axis of FIG. 36A indicates the primary voltage (voltage signal 62) detected by the voltage detection unit 53a in the detection spark discharge. The vertical axis of FIG. 36B indicates a time differential value dV/dt of the primary voltage (voltage signal 62) detected by the voltage detection unit 53a in the detection spark discharge.

The voltage change rate dV acquired by the voltage change rate acquisition unit 55j is calculated by a formula (5). That is, the voltage change rate dV acquired by the voltage change rate acquisition unit 55j is the average value of the time differential value dV/dt of the primary voltage (voltage signal 62) during the averaging period Tdm.

$$\begin{matrix}[ Formula 5 ] & \\ d V = \frac{{\int }_{{t}_{4}}^{{t}_{5}} \frac{d V}{d t} dt}{{T}_{d m}} & ( 5 )\end{matrix}$$

It is desirable that the period for averaging the time differential value of the voltage (averaging period Tdm) is between the middle period of the detection spark discharge and the final period of the discharge. More specifically, it is desirable that an averaging start timing t4 of the time differential value of the voltage is in the range of 40% to 60% of the discharge period Td after the start of the detection spark discharge. Further, it is desirable that an averaging end timing t5 of the time differential value of the voltage is in the range of 90% to 100% of the discharge period Td after the discharge start of the detection spark discharge. According to the experiments by the inventors, a desirable range of the averaging start timing t4 of the time differential value of the voltage is expressed by a formula (6). Further, a desirable range of the averaging end timing t5 of the time differential value of the voltage is expressed by a formula (7).

$$\begin{matrix}[ Formula 6 ] & \\ t 0 + 0 \text{.6} \times Td \geq t 4 \geq t 0 + 0.4 \times Td & ( 6 )\end{matrix}$$

$$\begin{matrix}[ Formula 7 ] & \\ t 0 + Td \geq t 5 \geq t 0 + 0.9 \times Td & ( 7 )\end{matrix}$$

The reason why the averaging start timing t4 and the averaging end timing t5 are within the above-described range is that changes in voltage behavior due to differences in in-cylinder pressure becomes noticeable mainly in the latter half of the detection spark discharge period. Further, the reason is that in the first half of the detection spark discharge period, the accuracy of the time differential value of the voltage decreases due to ringing noise.

### [In-Cylinder Pressure and Voltage Change Rate]

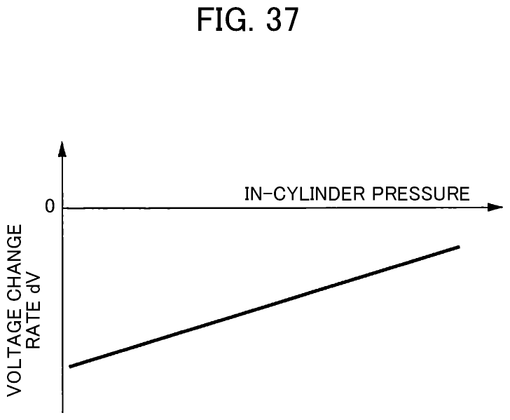

Next, the relationship between the in-cylinder pressure and the voltage change rate dV will be described using FIG. 37.

FIG. 37 is an explanatory diagram showing an example of the relationship between the in-cylinder pressure and the voltage change rate dV at the detection spark discharge timing according to the sixth embodiment.

As shown in FIG. 37, there is a high correlation between the in-cylinder pressure and the voltage change rate dV at the detection spark discharge timing. That is, the voltage change rate dV becomes smaller as the in-cylinder pressure at the detection spark discharge timing becomes lower. This is because the lower the in-cylinder pressure at the detection spark discharge timing, the smaller the amount of elongation of the discharge path in the detection spark discharge, and the voltage increase in the latter half of the detection spark discharge is suppressed. Therefore, during the misfire when the in-cylinder pressure at the detection spark discharge timing becomes low, the voltage change rate dV of the detection spark discharge becomes smaller than during the normal combustion when the in-cylinder pressure at the detection spark discharge timing becomes high.

Therefore, in the sixth embodiment, the upper limit value of the voltage change rate dV at the time of the misfire (voltage change rate comparison value dVc for misfire determination) is determined in advance by calibration or the like. Then, the determination unit 56j of the ECU 2 determines that a misfire has occurred if the voltage change rate dV of the detection spark discharge is smaller than the voltage change rate comparison value dVc. On the other hand, the determination unit 56j determines that the combustion is normal if the voltage change rate dV of the detection spark discharge is not smaller than the voltage change rate comparison value dVc.

### [Procedure for Misfire Detection Based on Voltage Change Rate by Software of ECU]

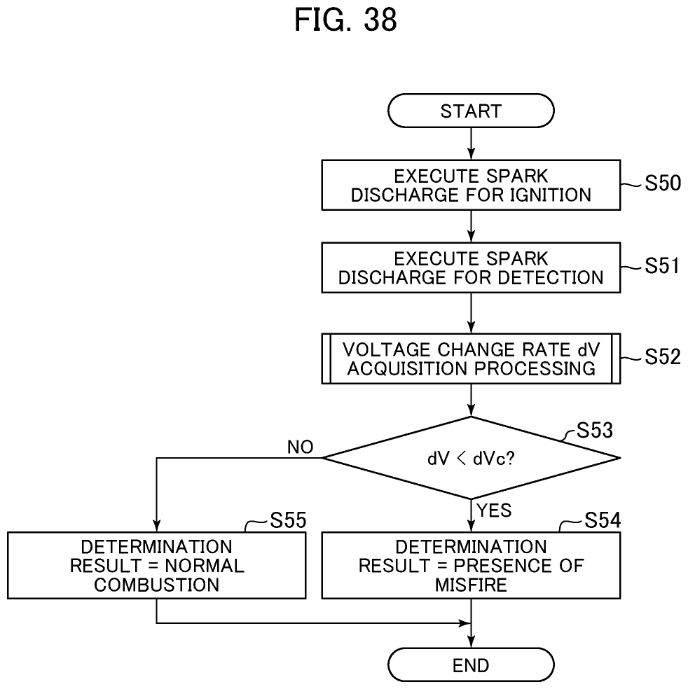

Next, a procedure for detecting a misfire based on the voltage change rate dV by software of the ECU 2 will be described using FIG. 38.

FIG. 38 is a flowchart showing the procedure of misfire detection processing according to the sixth embodiment.

In the combustion detection unit 1j shown in FIG. 35, the voltage change rate acquisition unit 55j and the determination unit 56j are arranged inside the ECU 2. Therefore, the acquisition of the voltage change rate dV and the misfire determination are executed by software running on the ECU 2.

As shown in FIG. 38, the ECU 2 sends an ignition signal to the igniter 54 in the ignition unit 51 from the latter half of the compression stroke to the early stage of the expansion stroke to execute a spark discharge for ignition (S50). Next, in the expansion stroke, the ECU 2 sends an ignition signal to the igniter 54 in the ignition unit 51 to execute a spark discharge for detection (S51). Next, the voltage change rate acquisition unit 55j of the ECU 2 performs voltage change rate dV acquisition processing (S52). In Step S52, the voltage change rate acquisition unit 55j acquires the voltage change rate dV from the voltage signal 62. Next, the determination unit 56j of the ECU 2 determines whether the voltage change rate dV is smaller than a predetermined voltage change rate comparison value dVc (S53).

In Step S53, when it is determined that the voltage change rate dV is not smaller than the voltage change rate comparison value dVc (NO in S53), the determination unit 56j of the ECU 2 determines that the combustion is normal (S55). After the processing of Step S55, the ECU 2 ends the misfire detection processing. On the other hand, when it is determined in Step S53 that the voltage change rate dV is smaller than the voltage change rate comparison value dVc (YES in S53), the determination unit 56j of the ECU 2 determines that there is a misfire (S54). After the processing of Step S54, the ECU 2 ends the misfire detection processing.

### [Voltage Change Rate dV Acquisition Processing]

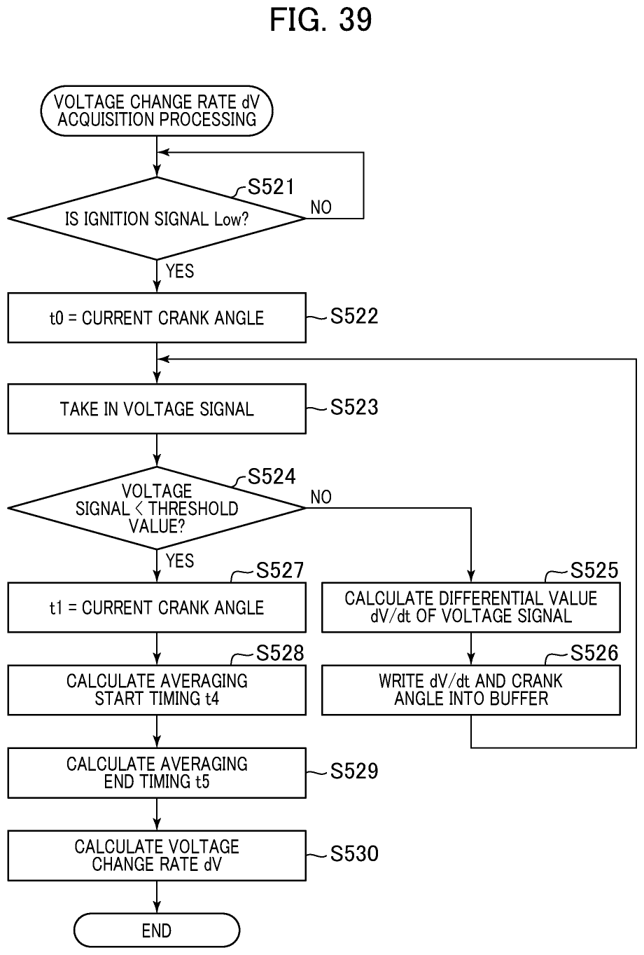

Next, the voltage change rate dV acquisition processing executed in Step S52 of the misfire detection processing shown in FIG. 38 will be described using FIG. 39.

FIG. 39 is a flowchart showing a procedure for calculating the voltage change rate dV by software of the ECU 2 in Step S52.

As shown in FIG. 39, the ECU 2 determines whether or not the ignition signal is Low (S521). In Step S521, when the ignition signal is not Low (NO in S521), Step S521 is repeated. In Step S521, when the ignition signal is Low (YES in S52a), the ECU 2 determines that the discharge has started, and sets the current crank angle to the discharge start timing to (S522).

Next, the ECU 2 takes in the voltage signal 62 in the detection spark discharge detected by the voltage detection unit 53a of the combustion detection unit 1j (S523). Then, the ECU 2 determines whether the voltage signal 62 is smaller than a predetermined energization determination threshold value (S524). In Step S524, when the voltage signal 62 is not smaller than the predetermined energization determination threshold value (NO in S524), the ECU 2 calculates the time differential value dV/dt of the voltage signal 62 (S525). Then, the ECU 2 writes the time differential value dV/dt of the voltage signal 62 and the current crank angle into the buffer (S526) After the processing of Step S526, the ECU 2 returns to Step S523.

In Step S524, when the voltage signal 62 is smaller than the predetermined energization determination threshold value (YES in S524), the ECU 2 determines that the discharge has ended, and sets the current crank angle to the discharge end timing t1 (S527). The energization determination threshold value is a value for determining a current energizing period. The energization determination threshold value is predetermined as a value sufficiently smaller than the average value of the voltage signal 62 during energization. The energization determination threshold value is, for example, the average value of the voltage signal 62 during energization×0.01.

Next, the ECU 2 calculates the averaging start timing t4 of the voltage differential value from the discharge start timing to and the discharge end timing t1 (S528). The averaging start timing t4 is calculated by the above-described formula (6), for example. Next, the ECU 2 calculates the averaging end timing t5 of the voltage differential value from the discharge start timing to and the discharge end timing t1 (S529). The averaging end timing t5 is calculated by the above-described formula (7), for example.

Next, the ECU 2 calculates the voltage change rate dV based on the voltage differential value dV/dt and the crank angle written into the buffer in Step S526 (S530). The voltage change rate dV is the average value of the voltage differential value from the averaging start timing t1 of the voltage differential value to the averaging end timing t5 of the voltage differential value. The voltage change rate dV is calculated by the above-described formula (5), for example. After the processing of Step S530, the ECU 2 ends the voltage change rate dV acquisition processing and executes Step S53 of the misfire detection processing shown in FIG. 38.

### [Changes in Peak Voltage Comparison Value and Discharge Period Comparison Value According to Operating State of Internal Combustion Engine]

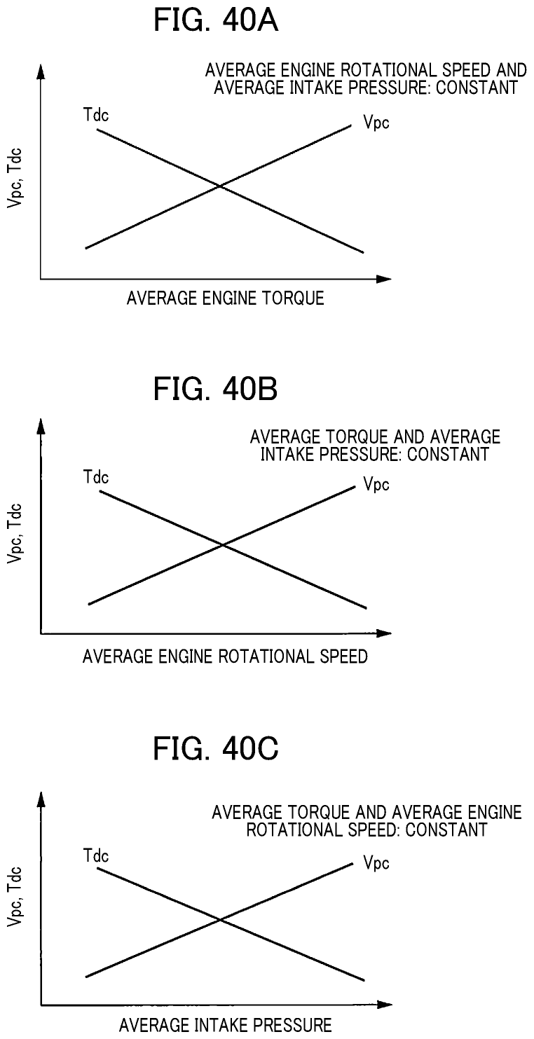

Next, a description will be made about changes in the voltage comparison value and the discharge period comparison value using FIGS. 40A, 40B, and 40C.

FIGS. 40A, 40B, and 40C are explanatory diagrams showing a desirable method of changing the peak voltage comparison value Vpc and the discharge period comparison value Tdc with respect to changes in engine (internal combustion engine) torque, engine (internal combustion engine) rotational speed, and intake pressure.

In the first embodiment, second embodiment, third embodiment, and fifth embodiment described above, it is preferable to appropriately define the peak voltage comparison value Vpc and the discharge period comparison value Tdc for determining the misfire and the normal combustion according to the operating state of the internal combustion engine 13 (engine). Thus, even when the operating state of the internal combustion engine 13 is changed, the accuracy of misfire detection can be kept high.

The graph in FIG. 40A shows an example of the relationship between the average engine torque and the desired peak voltage comparison value Vpc and discharge period comparison value Tdc. The graph in FIG. 40B shows an example of the relationship between the average engine rotational speed and the desired peak voltage comparison value Vpc and discharge period comparison value Tdc. The graph in FIG. 40C shows an example of the relationship between the average intake pressure and the desired peak voltage comparison value Vpc and discharge period comparison value Tdc. Here, the term “average” means the average value of multiple cycles of the engine (internal combustion engine), and for example, indicates the average value of 100 cycles of the engine.

When the average engine torque is high, the average in-cylinder pressure during the expansion stroke becomes higher than when the average engine torque is low. Therefore, as shown in FIG. 40A, when the average engine torque is high, it is desirable to increase the peak voltage comparison value Vpc and decrease the discharge period comparison value Tdc as compared to when the average engine torque is low.

When the average engine rotational speed is high, the extension of the detection spark discharge becomes greater than when the average engine rotational speed is low. Therefore, as shown in FIG. 40B, when the average engine rotational speed is high, it is desirable to increase the peak voltage comparison value Vpc and decrease the discharge period comparison value Tdc as compared to when the average engine rotational speed is low.

When the average intake pressure is high, the average in-cylinder pressure during the expansion stroke becomes higher than when the average intake pressure is low. Therefore, as shown in FIG. 40C, when the average intake pressure is high, it is desirable to increase the peak voltage comparison value Vpc and decrease the discharge period comparison value Tdc compared to when the average intake pressure is low.

### [Change of Voltage Comparison Value and Voltage Change Rate Comparison Value]

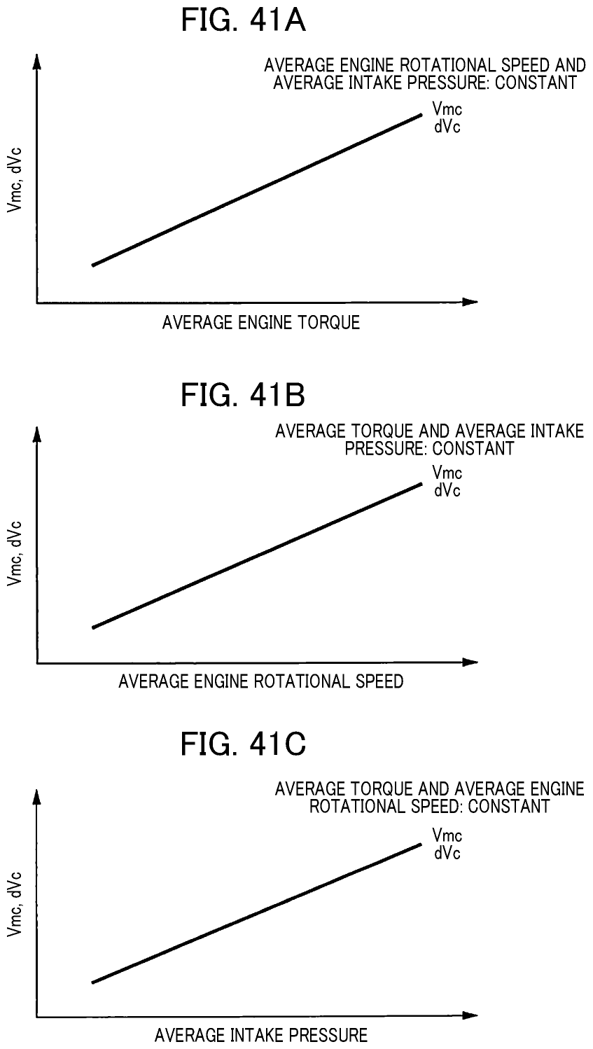

Next, a description will be made about changes in the voltage comparison value and the voltage change rate comparison value using FIGS. 41A, 41B, and 41C.

FIGS. 41A, 41B, and 41C are explanatory diagrams showing a desirable method of changing the average voltage comparison value Vmc and the voltage change rate comparison value dVc with respect to changes in engine (internal combustion engine) torque, engine (internal combustion engine) rotational speed, and intake pressure.

In the fourth embodiment, the fifth embodiment, and the sixth embodiment described above, the average voltage comparison value Vmc and the voltage change rate comparison value dVc for determining the misfire and the normal combustion may be appropriately defined according to the operating state of the internal combustion engine 13 (engine). Thus, even when the operating state of the internal combustion engine 13 is changed, the accuracy of misfire detection can be kept high.

The graph in FIG. 41A indicates an example of the relationship between the average engine torque and the desired average voltage comparison value Vmc and voltage change rate comparison value dVc. The graph in FIG. 41B indicates an example of the relationship between the average engine rotational speed and the desired average voltage comparison value Vmc and voltage change rate comparison value dVc. The graph in FIG. 41C indicates an example of the relationship between the average intake pressure and the desired average voltage comparison value Vmc and voltage change rate comparison value dVc. Here, the term “average” means the average value of multiple cycles of the engine (internal combustion engine), and for example, indicates the average value of 100 cycles of the engine.

When the average engine torque is high, the average in-cylinder pressure during the expansion stroke becomes higher than when the average engine torque is low. Therefore, as shown in FIG. 41A, when the average engine torque is high, it is desirable to make the average voltage comparison value Vmc and the voltage change rate comparison value dVc larger than when the average engine torque is low.

When the average engine rotational speed is high, the extension of the detection spark discharge becomes greater than when the average engine rotational speed is low. Therefore, as shown in FIG. 41B, when the average engine rotational speed is high, it is desirable to make the average voltage comparison value Vmc and the voltage change rate comparison value dVc larger than when the average engine rotational speed is low.

When the average intake pressure is high, the average in-cylinder pressure during the expansion stroke becomes higher than when the average intake pressure is low. Therefore, as shown in FIG. 41C, when the average intake pressure is high, it is desirable to make the average voltage comparison value Vmc and the voltage change rate comparison value dVc larger than when the average intake pressure is low.

### Summary

(1) The combustion state detection device of the internal combustion engine according to the first embodiment described above includes the peak voltage acquisition units 55a and 55b (peak voltage acquisition units) and the determination units 56a and 56b (determination units). The peak voltage acquisition units 55a and 55b respectively obtain the end-of-discharge peak voltage Vp (peak voltage value at the end of discharge) based on the voltage of the ignition coil 52 (ignition coil) connected to the spark plug 40 (spark plug) which performs discharge. The determination units 56a and 56b respectively compare the end-of-discharge peak voltage Vp acquired by each of the peak voltage acquisition units 55a and 55b with the peak voltage comparison value Vpc (peak voltage comparison value). The spark plug 40 performs the ignition spark discharge to ignite the air-fuel mixture and the detection spark discharge in the same engine cycle after the ignition spark discharge. Then, the determination units 56a and 56b respectively determine that the misfire has occurred when the end-of-discharge peak voltage Vp of the detection spark discharge is smaller than the peak voltage comparison value Vpc.

Thereby, even if the fuel does not generate ions through combustion, the misfire can be easily detected from the end-of-discharge peak voltage Vp. That is, the misfire can be detected regardless of the type of fuel. Further, since the misfire is not detected based on the presence or absence of breakdown (dielectric breakdown), there is no need to determine an appropriate applied voltage when executing the detection spark discharge, and robustness can be prevented from decreasing.

(2) The peak voltage comparison value Vpc (peak voltage comparison value) in the combustion state detection device for the internal combustion engine according to the first embodiment described above is changed depending on the operating state of the internal combustion engine.

Thus, even if the operating state of the internal combustion engine changes, it is possible to keep high the accuracy of the misfire detection based on the end-of-discharge peak voltage Vp.

(3) The peak voltage comparison value Vpc (voltage comparison value) in the combustion state detection device for the internal combustion engine according to the first embodiment described above increases as the engine torque, the engine rotational speed or the intake pressure increases.

Thus, even if the engine torque, the engine rotational speed or the intake pressure changes, it is possible to keep high the accuracy of the misfire detection based on the end-of-discharge peak voltage Vp.

(4) The combustion state detection device for the internal combustion engine according to the first embodiment described above includes the voltage detection unit 53a (voltage detection unit) which detects the voltage of the ignition coil 52 (ignition coil).

Thus, it is possible to easily supply information about the voltage of the ignition coil 52 to the peak voltage acquisition units 55a and 55b (peak voltage acquisition units). Further, the ignition device 3A can be provided with the combustion state detection device (peak voltage acquisition unit 55a, determination unit 56a, and voltage detection unit 53a). In this case, the detection result of the misfire state can be supplied to the ECU 2 by receiving the ignition signal for performing the detection spark discharge from the ECU 2.

(5) The peak voltage acquisition unit 55b (peak voltage acquisition unit) and the determination unit 56b (determination unit) in the combustion state detection device for the internal combustion engine according to the first embodiment described above are included in the ECU 2 (control unit) which outputs the ignition signal for causing the spark plug 40 (spark plug) to perform the ignition spark discharge and the detection spark discharge. Then, the voltage detection unit 53a (voltage detection unit) detects the voltage value obtained by stepping down the primary voltage of the ignition coil 52 (ignition coil) or the secondary voltage reversed in polarity, and sends the detected voltage value to the peak voltage acquisition unit 55b.

Thus, the processing of acquiring the end-of-discharge peak voltage Vp and the processing of detecting the combustion state (misfire determination) can be executed by software running on the ECU 2. In this case, for example, the misfire determination condition (peak voltage comparison value Vpc) can be flexibly changed according to the operating state of the internal combustion engine 13. Therefore, it is possible to optimize the detection of the combustion state and reduce the cost of hardware. Further, since the voltage detection unit 53a detects the voltage value obtained by stepping down the primary voltage of the ignition coil 52 or the secondary voltage reversed in polarity, the voltage sent to the peak voltage acquisition unit 55b can be in the voltage range normally handled inside the ECU 2. Thus, it is possible to suppress an increase in the hardware cost of the ECU 2.

(6) The combustion state detection device for the internal combustion engine according to the second embodiment described above includes the discharge period acquisition units 55c and 55d (discharge period acquisition units) and the determination units 56c and 56d (determination units). The discharge period acquisition units 55c and 55d respectively acquire the discharge period Td (discharge period) based on the current of the ignition coil 52 (ignition coil) connected to the spark plug 40 (spark plug) which performs discharge. The determination units 56c and 56d respectively compare the discharge period Td acquired by each of the discharge period acquisition units 55c and 55d with the discharge period comparison value Tdc (discharge period comparison value). The spark plug 40 performs the ignition spark discharge in order to ignite the air-fuel mixture and the detection spark discharge in the same engine cycle after the ignition spark discharge. Then, the determination units 56c and 56d respectively determine that the misfire has occurred when the discharge period Td of the detection spark discharge is greater than the discharge period comparison value Tdc.

Thus, even if the fuel does not generate ions through combustion, the misfire can be easily detected from the discharge period Td. That is, the misfire can be detected regardless of the type of fuel. Further, since the misfire is not detected based on the presence or absence of breakdown (dielectric breakdown), there is no need to determine an appropriate applied voltage when executing the detection spark discharge, and robustness can be prevented from decreasing.

(7) The combustion state detection device for the internal combustion engine according to the second embodiment described above changes the discharge period comparison value Tdc (discharge period comparison value) according to the operating state of the internal combustion engine.

Thus, even if the operating state of the internal combustion engine changes, it is possible to keep high the accuracy of misfire detection based on the discharge period Td.

(8) The discharge period comparison value Tdc in the combustion state detection device for the internal combustion engine according to the second embodiment described above decreases as the engine torque, the engine rotational speed, or the intake pressure rises.

Thus, even if the engine torque, the engine rotational speed or the intake pressure changes, it is possible to keep high the accuracy of misfire detection based on the discharge period Td.

(9) The combustion state detection device for the internal combustion engine according to the second embodiment described above includes the current detection unit 53c (current detection unit) which detects the current of the ignition coil 52 (ignition coil).

Thus, it is possible to easily supply information about the current of the ignition coil 52 to the discharge period acquisition units 55c and 55d (discharge period acquisition units). Further, the ignition device 3C can be provided with the combustion state detection device (discharge period acquisition unit 55c, determination unit 56c, and current detection unit 53c). In this case, the detection result of the misfire state can be supplied to the ECU 2 by receiving the ignition signal for performing the detection spark discharge from the ECU 2.

(10) The discharge period acquisition unit 55d (discharge period acquisition unit) and the determination unit 56d (determination unit) in the combustion state detection device for the internal combustion engine according to the second embodiment described above are included in the ECU 2 (control unit) which outputs the ignition signal for allowing the spark plug 40 (spark plug) to execute the ignition spark discharge and the detection spark discharge. Then, the current detection unit 53c (current detection unit) detects the secondary current value of the ignition coil 52 (ignition coil) and sends the detected secondary current value to the discharge period acquisition unit 55d.

Thus, the processing of acquiring the discharge period Td and the processing of detecting the combustion state (misfire determination) can be executed by software running on the ECU 2. In this case, for example, the misfire determination condition (discharge period comparison value Tdc) can be flexibly changed according to the operating state of the internal combustion engine 13. Therefore, it is possible to optimize the detection of the combustion state and reduce the cost of hardware.

(11) The combustion state detection device for the internal combustion engine according to the third embodiment described above includes the discharge period acquisition units 55e and 55f (discharge period acquisition units) and the determination units 56c and 56d (determination units). The discharge period acquisition units 55e and 55f respectively acquires the discharge period Td (discharge period) based on the primary voltage of the ignition coil 52 (ignition coil) connected to the spark plug 40 (spark plug) which performs discharge. The determination units 56c and 56d respectively compare the discharge period Td acquired by each of the discharge period acquisition units 55e and 55f with the discharge period comparison value Tdc (discharge period comparison value). The spark plug 40 performs the ignition spark discharge to ignite the air-fuel mixture and the detection spark discharge in the same engine cycle after the ignition spark discharge. Then, the determination units 56c and 56d respectively determine that the misfire has occurred when the discharge period Td of the detection spark discharge is greater than the discharge period comparison value Tdc.

Thus, even if the fuel does not generate ions through combustion, the misfire can be easily detected from the discharge period Td. That is, the misfire can be detected regardless of the type of fuel. Further, since the misfire is not detected based on the presence or absence of breakdown (dielectric breakdown), there is no need to determine the appropriate applied voltage when executing the detection spark discharge. As a result, it is possible to prevent the robustness from becoming low.

(12) The determination units 56c and 56d (determination units) of the combustion state detection devices for the internal combustion engine according to the third embodiment described above change the discharge period comparison value Tdc (discharge period comparison value) according to the operating state of the internal combustion engine.

Thus, even if the operating state of the internal combustion engine changes, it is possible to keep high the accuracy of misfire detection based on the discharge period Td.

(13) The discharge period comparison value Tdc in the combustion state detection device for the internal combustion engine according to the third embodiment described above decreases as the engine torque, the engine rotational speed or the intake pressure rises.

Thus, even if the engine torque, the engine rotational speed or the intake pressure changes, it is possible to keep high the accuracy of misfire detection based on the discharge period Td.

(14) The combustion state detection device for the internal combustion engine according to the third embodiment described above includes the voltage detection unit 53e (voltage detection unit) which detects the primary voltage of the ignition coil 52 (ignition coil).

Thus, it is possible to easily supply information about the voltage of the ignition coil 52 to the discharge period acquisition units 55e and 55f (discharge period acquisition units). Further, the ignition device 3E can be provided with the combustion state detection device (discharge period acquisition unit 55e, determination unit 56c, and voltage detection unit 53e). In this case, the detection result of the misfire state can be supplied to the ECU 2 by receiving the ignition signal for performing the detection spark discharge from the ECU 2.

(15) The discharge period acquisition unit 55f (discharge period acquisition unit) and the determination unit 56d (determination unit) in the combustion state detection device for the internal combustion engine according to the third embodiment described above are included in the ECU 2 (control unit) which outputs the ignition signal for allowing the spark plug 40 (spark plug) to execute the ignition spark discharge and the detection spark discharge. Then, the voltage detection unit 53e (voltage detection unit) detects the primary voltage value of the ignition coil 52 (ignition coil) and sends the detected voltage value to the discharge period acquisition unit 55f.

Thus, the processing of acquiring the discharge period Td and the processing of detecting the combustion state (misfire determination) can be executed by software running on the ECU 2. In this case, for example, the misfire determination condition (discharge period comparison value Tdc) can be flexibly changed according to the operating state of the internal combustion engine 13. Therefore, it is possible to optimize the detection of the combustion state and reduce the cost of hardware.

(16) The combustion state detection device for the internal combustion engine according to the fourth embodiment described above includes the average voltage acquisition units 55g and 55h (average voltage acquisition units) and the determination units 56g and 56h (determination units). The average voltage acquisition units 55g and 55h acquire the average voltage Vm based on the voltage of the ignition coil 52 (ignition coil) connected to the spark plug 40 (spark plug) which performs discharge. The determination units 56g and 56h respectively compare the average voltage Vm acquired by each of the average voltage acquisition units 55g and 55h with the average voltage comparison value Vmc. The spark plug 40 performs the ignition spark discharge to ignite the air-fuel mixture and the detection spark discharge in the same engine cycle after the ignition spark discharge. Then, the determination units 56g and 56h determines that the misfire has occurred when the average voltage Vm of the detection spark discharge is smaller than the average voltage comparison value Vmc.

Thus, even if the fuel does not generate ions through combustion, it is possible to easily detect the misfire from the average voltage Vm. That is, the misfire can be detected regardless of the type of fuel. Further, since the misfire is not detected based on the presence or absence of breakdown (dielectric breakdown), there is no need to determine the appropriate applied voltage when executing the detection spark discharge. As a result, it is possible to prevent the robustness from becoming low.

(17) The average voltage comparison value Vmc in the combustion state detection device for the internal combustion engine according to the fourth embodiment described above is changed according to the operating state of the internal combustion engine.

Thus, even if the operating state of the internal combustion engine changes, it is possible to keep high the accuracy of misfire detection based on the average voltage Vm.

(18) The average voltage comparison value Vmc in the combustion state detection device for the internal combustion engine according to the fourth embodiment described above increases as the engine torque, the engine rotational speed or the intake pressure rises.

Thus, even if the engine torque, the engine rotational speed or the intake pressure changes, it is possible to keep high the accuracy of misfire detection based on the average voltage Vm.

(19) The combustion state detection device for the internal combustion engine according to the fourth embodiment described above includes the voltage detection unit 53a (voltage detection unit) which detects the voltage of the ignition coil 52 (ignition coil).

Thus, it is possible to easily supply information about the voltage of the ignition coil 52 to the average voltage acquisition units 55g and 55h (average voltage acquisition units). Further, the ignition device 3G can be provided with the combustion state detection device (average voltage acquisition unit 55g, determination unit 56g, and voltage detection unit 53a). In this case, the detection result of the misfire state can be supplied to the ECU 2 by receiving the ignition signal for performing the detection spark discharge from the ECU 2.

(20) The average voltage acquisition unit 55h (average voltage acquisition unit) and the determination unit 56h (determination unit) in the combustion state detection device for the internal combustion engine according to the fourth embodiment described above are included in the ECU 2 (control unit) which outputs the ignition signal for allowing the spark plug 40 (spark plug) to perform the ignition spark discharge and the detection spark discharge. Then, the voltage detection unit 53a (voltage detection unit) detects the voltage value obtained by stepping down the primary voltage of the ignition coil 52 (ignition coil) or the secondary voltage reversed in polarity, and sends the detected voltage value to the average voltage acquisition unit 55h.

Thus, the processing of acquiring the average voltage Vm and the processing of detecting the combustion state (misfire determination) can be executed by software running on the ECU 2. In this case, for example, the misfire determination condition (average voltage comparison value Vmc) can be flexibly changed according to the operating state of the internal combustion engine 13. Therefore, it is possible to optimize the detection of the combustion state and reduce the cost of hardware. Further, since the voltage detection unit 53a detects the voltage value obtained by stepping down the primary voltage of the ignition coil 52 or the secondary voltage reversed in polarity, the voltage sent to the average voltage acquisition unit 55h can be in the voltage range normally handled inside the ECU 2. Thus, it is possible to suppress an increase in the hardware cost of the ECU 2.

(21) The combustion state detection device for the internal combustion engine according to the fifth embodiment described above includes the peak voltage acquisition unit 55b (peak voltage acquisition unit), the average voltage acquisition unit 55h (average voltage acquisition unit), and the determination unit 56i (determination unit). The peak voltage acquisition unit 55b acquires the end-of-discharge peak voltage Vp (peak voltage value at the end of discharge) based on the voltage of the ignition coil 52 (ignition coil) connected to the spark plug 40 (spark plug) which performs discharge. The average voltage acquisition unit 55h acquires the average voltage Vm (average voltage) based on the voltage of the ignition coil 52 (ignition coil) connected to the spark plug 40 (ignition plug) which performs discharge. The spark plug 40 performs the ignition spark discharge to ignite the air-fuel mixture and the detection spark discharge in the same engine cycle after the ignition spark discharge. The determination unit 56i performs comparison between the detection spark discharge timing θd (detection spark discharge timing) and the timing comparison value Od (timing comparison value). Then, when the detection spark discharge timing ed is larger than the timing comparison value Od, the determination unit 56i performs comparison between the average voltage Vm acquired by the average voltage acquisition unit 55h and the average voltage comparison value Vmc (average voltage comparison value), and determines that the misfire has occurred when the average voltage Vm of the detection spark discharge is smaller than the average voltage comparison value Vmc. Further, when the detection spark discharge timing ed is not larger than the timing comparison value Od, the determination unit 56i performs comparison between the end-of-discharge peak voltage Vp acquired by the peak voltage acquisition unit 55b and the peak voltage comparison value Vpc (peak voltage comparison value), and determines that the misfire has occurred when the end-of-discharge peak voltage Vp of the detection spark discharge is smaller than the peak voltage comparison value Vpc.

Thus, even if the fuel does not generate ions through combustion, it is possible to easily detect the misfire from the average voltage Vm or the end-of-discharge peak voltage Vp. That is, the misfire can be detected regardless of the type of fuel. Further, since the misfire is not detected based on the presence or absence of breakdown (dielectric breakdown), there is no need to determine the appropriate applied voltage when executing the detection spark discharge. As a result, it is possible to prevent the robustness from becoming low. Further, since the misfire determination based on the peak voltage Vp and the misfire determination based on the average voltage Vm are switched based on the detection spark discharge timing ed, it is possible to obtain high misfire detection accuracy even when the detection spark discharge timing ed changes.

(22) The average voltage comparison value Vmc and the peak voltage comparison value Vpc in the combustion state detection device for the internal combustion engine according to the fifth embodiment described above are changed according to the operating state of the internal combustion engine.

Thus, even if the operating state of the internal combustion engine changes, it is possible to keep high the accuracy of misfire detection based on the average voltage Vm and the accuracy of misfire detection based on the peak voltage Vp.

(23) The average voltage comparison value Vmc and the peak voltage comparison value Vp in the combustion state detection device for the internal combustion engine according to the fifth embodiment described above increases as the engine torque, the engine rotational speed or the intake pressure rises.

Thus, even if the engine torque, the engine rotational speed or the intake pressure changes, the accuracy of misfire detection based on the average voltage Vm and misfire detection based on the peak voltage Vp can be kept with high accuracy.

(24) The timing comparison value ed (timing comparison value) in the combustion state detection device for the internal combustion engine according to the fifth embodiment described above is changed according to the operating state of the internal combustion engine.

Thus, even if the operating state of the internal combustion engine changes, it is possible to keep high the accuracy of misfire detection based on the average voltage Vm and the accuracy of misfire detection based on the peak voltage Vp.

(25) The combustion state detection device for the internal combustion engine according to the sixth embodiment described above includes the voltage change rate acquisition unit 55j (voltage change rate acquisition unit) and the determination unit 56j (determination unit). The voltage change rate acquisition unit 55j acquires the voltage change rate dV (voltage change rate) based on the voltage of the ignition coil 52 (ignition coil) connected to the spark plug 40 (spark plug) which performs discharge. The determination unit 56j compares the voltage change rate dV acquired by the voltage change rate 55j with the voltage change rate comparison value dVc (voltage change rate comparison value). The spark plug 40 performs the ignition spark discharge to ignite the air-fuel mixture and the detection spark discharge in the same engine cycle after the ignition spark discharge. Then, the determination unit 56j determines that the misfire has occurred when the voltage change rate dV of the detection spark discharge is smaller than the voltage change rate comparison value dVc.

Thus, even if the fuel does not generate ions through combustion, it is possible to easily detect the misfire from the voltage change rate dV. That is, the misfire can be detected regardless of the type of fuel. Further, since the misfire is not detected based on the presence or absence of breakdown (dielectric breakdown), there is no need to determine the appropriate applied voltage when executing the detection spark discharge. As a result, it is possible to prevent the robustness from becoming low.

(26) The voltage change rate comparison value dVc (voltage change rate comparison value) in the combustion state detection device for the internal combustion engine according to the sixth embodiment described above is changed according to the operating state of the internal combustion engine.

Thus, even if the operating state of the internal combustion engine changes, it is possible to keep high the accuracy of misfire detection based on the voltage change rate dV.

(27) The voltage change rate comparison value dVc (voltage change rate comparison value) in the combustion state detection device for the internal combustion engine according to the sixth embodiment described above increases as the engine torque, the engine rotational speed or the intake pressure rises.

Thus, even if the engine torque, the engine rotational speed or the intake pressure changes, the accuracy of misfire detection based on the voltage change rate dV can be kept high.

(28) In the combustion state detection device for the internal combustion engine according to the first to sixth embodiments described above, the timing of the detection spark discharge is within the range from the 20° advance timing for the timing of the combustion mass rate 90% to the 40° retard timing for the timing of the combustion mass rate 90%.

Thus, the detection of a misfire state is not affected by breakdown assistance by ions generated by combustion. As a result, the misfire can be detected even with the fuel (for example, hydrogen or ammonia) which generates few ions by combustion.

(29) In the detection spark discharge according to the first to sixth embodiments described above, the time (ON period of ignition signal) for storing magnetic energy in the ignition coil 52 (ignition coil) in the detection spark discharge so that the spark discharge is accompanied by the breakdown regardless of the presence or absence of the misfire.

Thus, it is not necessary to determine the applied voltage for the detection spark discharge such that breakdown occurs during the misfire and does not occur during the normal combustion. Therefore, the robust detection of misfire state can be done with respect to the changes in the operating state and environmental state of the internal combustion engine 13.

(30) In the detection spark discharge according to the first to sixth embodiments described above, when the timing at which the detection ignition signal is sent out is on the advance side of the expansion stroke, the time (ON period of ignition signal) during which magnetic energy is stored in the ignition coil 52 (ignition coil) in the detection spark discharge is made longer than when the timing at which the detection ignition signal is sent out is on the retard side of the expansion stroke. Further, when the load (torque) of the internal combustion engine is high, the time (ON period of ignition signal) during which the magnetic energy is stored in the ignition coil 52 (ignition coil) in the detection spark discharge is made longer than when the load of the internal combustion engine is low.

This can reduce the risk of spark discharge (breakdown) occurring when the timing at which the detection ignition signal is sent is on the advance side of the expansion stroke or when the load (torque) of the internal combustion engine is high.

(31) In the combustion state detection device for the internal combustion engine according to the first embodiment and the fourth to sixth embodiments described above, the voltage detection unit 53a (voltage detection unit) which detects the voltage of the ignition coil 52 (ignition coil) detects the primary voltage of the ignition coil 52.

This can reduce the cost of hardware. Further, it is possible to improve safety and reliability.

The present invention is not limited to the embodiments described above and illustrated in the drawings, and various modifications can be made within the scope not departing from the gist of the invention as set forth in the claims.

For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

For example, the combustion detection units (combustion state detection device for the internal combustion engine) 1a and 1b according to the first embodiment described above respectively include the voltage detection unit 53a, but the combustion state detection device for the internal combustion engine according to the present invention may not include the voltage detection unit 53a. In this case, for example, the combustion state detection device can be configured only by the ECU. Then, the ECU acquires the end-of-discharge peak voltage based on the voltage value of the ignition coil suppled from the ignition device, and detects a misfire state (combustion state) based on the end-of-discharge peak voltage.

Further, the combustion detection units (combustion state detection device for the internal combustion engine) 1c and 1d according to the second embodiment described above respectively include the current detection unit 53c, but the combustion state detection device for the internal combustion engine according to the present invention may not include the current detection unit 53c. In this case, for example, the combustion state detection device can be configured only by the ECU. Then, the ECU acquires the discharge period based on the current value of the ignition coil supplied from the ignition device, and detects a misfire state (combustion state) based on the discharge period.

Further, the combustion detection units (combustion state detection device for the internal combustion engine) 1e and 1f according to the third embodiment described above respectively include the voltage detection unit 53e. However, the combustion state detection device for the internal combustion engine according to the present invention may not include the voltage detection unit 53e. In this case, for example, the combustion state detection device can be configured only by the ECU. Then, the ECU acquires a discharge period based on the voltage value of the ignition coil supplied from the ignition device, and detects a misfire state (combustion state) based on the discharge period.

Further, the combustion detection units (combustion state detection device for the internal combustion engine) 1g and 1h according to the fourth embodiment described above respectively include the voltage detection unit 53a. However, the combustion state detection device for the internal combustion engine according to the present invention may not include the voltage detection unit 53a. In this case, for example, the combustion state detection device can be configured only by the ECU. Then, the ECU acquires an average voltage based on the voltage value of the ignition coil supplied from the ignition device, and detects a misfire state (combustion state) based on the average voltage.

Further, the combustion detection unit (combustion state detection device for the internal combustion engine) 1i according to the fifth embodiment described above includes the voltage detection unit 53a. However, the combustion state detection device for the internal combustion engine according to the present invention may not include the voltage detection unit 53a. In this case, for example, the combustion state detection device can be configured only by the ECU. Then, the ECU acquires an average voltage and a peak voltage based on the voltage value of the ignition coil supplied from the ignition device, and detects a misfire state (combustion state) based on the average voltage and the peak voltage.

Further, the combustion detection unit (combustion state detection device for the internal combustion engine) 1j according to the sixth embodiment described above includes the voltage detection unit 53a. However, the combustion state detection device for the internal combustion engine according to the present invention may not include the voltage detection unit 53a. In this case, for example, the combustion state detection device can be configured only by the ECU. Then, the ECU acquires a voltage change rate based on the voltage value of the ignition coil supplied from the ignition device, and detects a misfire state (combustion state) based on the voltage change rate.

### LIST OF REFERENCE SIGNS

1, 1′, 1a, 1b, 1c, 1d, 1e, 1f, 1g, 1 h, 1i, 1j . . . combustion detection unit (combustion state detection device), 2 . . . ECU (control unit), 3, 3′, 3A, 3B, 3C, 3D, 3E, 3F, 3G, 3H, 3I, 3J . . . ignition device, 4 . . . voltage output unit, 5 . . . current output unit, 13 . . . internal combustion engine (engine), 31 . . . intake manifold, 32 . . . intake valve, 33 . . . exhaust manifold, 34 . . . exhaust valve, 35 . . . piston, 36 . . . injector, 37 . . . combustion chamber, 38 . . . cylinder, 40 . . . spark plug, 41 . . . ignition gap, 48 . . . high tension cord, 51 . . . ignition unit, 52 . . . ignition coil, 52a . . . primary coil, 52b . . . secondary coil, 53 . . . discharge amount detection unit, 53a, 53e . . . voltage detection unit, 53c . . . current detection unit, 54 . . . igniter, 55, 55′ . . . discharge feature amount acquisition unit, 55a, 55b . . . peak voltage acquisition unit, 55c, 55d, 55e, 55f . . . discharge period acquisition unit, 55h . . . average voltage acquisition unit, 55j . . . voltage change rate acquisition unit, 56, 56′, 56a, 56b, 56c, 56d, 56g, 56h, 56i, 56j . . . determination unit, 62, 62e . . . voltage signal, 65 . . . current signal, 66 . . . trigger generation circuit, 67 . . . peak hold circuit, 68, 68a, 68b . . . comparison circuit, 69 . . . absolute value circuit, 70 . . . clock generation circuit, 71 . . . integration circuit

1. A combustion state detection device for an internal combustion engine, comprising:
a discharge feature amount acquisition unit which acquires a discharge feature amount based on a voltage value or a current value of an ignition coil connected to a spark plug of the internal combustion engine; and
a determination unit which compares the discharge feature amount acquired by the discharge feature amount acquisition unit with a predetermined determination threshold value, wherein
the spark plug executes an ignition spark discharge for igniting an air-fuel mixture and a detection spark discharge in the same engine cycle after the ignition spark discharge,
the discharge feature amount acquisition unit acquires the discharge feature amount based on the voltage value or current value of the ignition coil in the detection spark discharge, and
the determination unit determines whether the internal combustion engine is in a misfire state or a non-misfire state based on the comparison between the discharge feature amount and the predetermined determination threshold value.

2. The combustion state detection device for the internal combustion engine according to claim 1, wherein
the discharge feature amount acquisition unit acquires a peak voltage value of the ignition coil at the end of a discharge period of the detection spark discharge based on the voltage value of the ignition coil, and
the determination unit determines that the internal combustion engine is in the misfire state when the peak voltage value is smaller than a predetermined peak voltage threshold value.

3. The combustion state detection device for the internal combustion engine according to claim 1, wherein
the discharge feature amount acquisition unit acquires a discharge period of the detection spark discharge based on a secondary current value of the ignition coil, and
the determination unit determines that the internal combustion engine is in the misfire state when the discharge period of the detection spark discharge is larger than a predetermined discharge period determination threshold value.

4. The combustion state detection device for the internal combustion engine according to claim 1, wherein
the discharge feature amount acquisition unit acquires a discharge period of the detection spark discharge based on a primary voltage value of the ignition coil, and
the determination unit determines that the internal combustion engine is in the misfire state when the discharge period of the detection spark discharge is larger than a predetermined discharge period determination threshold value.

5. The combustion state detection device for the internal combustion engine according to claim 1, wherein
the discharge feature amount acquisition unit acquires an average voltage value of the ignition coil during a predetermined averaging period of the detection spark discharge based on the voltage value of the ignition coil, and
the determination unit determines that the internal combustion engine is in the misfire state when the average voltage value is smaller than a predetermined average voltage determination threshold value.

6. The combustion state detection device for the internal combustion engine according to claim 1, wherein
the discharge feature amount acquisition unit acquires a peak voltage value of the ignition coil at the end of a discharge period of the detection spark discharge based on the voltage value of the ignition coil, and an average voltage value of the ignition coil during a predetermined averaging period of the detection spark discharge,
when the timing of the detection spark discharge is later than a predetermined timing determination threshold value, the determination unit determines that the internal combustion engine is in the misfire state when the average voltage value is smaller than a predetermined average voltage determination threshold value, and
when the timing of the detection spark discharge is not later than a predetermined timing determination threshold value, the determination unit determines that the internal combustion engine is in the misfire state when the peak voltage value is smaller than a predetermined peak voltage determination threshold value.

7. The combustion state detection device for the internal combustion engine according to claim 6, wherein
the determination unit changes the predetermined timing determination threshold value according to the operating state of the internal combustion engine.

8. The combustion state detection device for the internal combustion engine according to claim 5, wherein
when the timing at which the detection spark discharge starts is t0, the timing at which the predetermined averaging period starts is t2, the timing at which the predetermined averaging period ends is t3, and the discharge period of the detection spark discharge is Td, the range of t2 is expressed by the following formula (1), and the range of t3 is expressed by the following formula (2):
$$\begin{matrix}( formula 1 ) & \\ t 0 + 0.9 \times T d > t 2 \geq t 0 + 0.5 \times Td & ( 1 )\end{matrix}$$
$$\begin{matrix}( formula 2 ) & \\ t 0 + T d \geq t 3 \geq t 0 + 0.9 \times Td . & ( 2 )\end{matrix}$$

9. The combustion state detection device for the internal combustion engine according to claim 1, wherein
the discharge feature amount acquisition unit acquires a voltage change rate during a discharge period of the detection spark discharge based on the voltage value of the ignition coil, and
the determination unit determines that the internal combustion engine is in the misfire state when the voltage change rate is smaller than a predetermined voltage change rate determination threshold value.

10. The combustion state detection device for the internal combustion engine according to claim 9, wherein
the voltage change rate is an average value of a time differential value of the voltage during a predetermined averaging period of the detection spark discharge.

11. The combustion state detection device for the internal combustion engine according to claim 10, wherein
the timing at which the detection spark discharge starts is to, the timing at which the predetermined averaging period starts is t4, the timing at which the predetermined averaging period ends is t5, and the discharge period of the detection spark discharge is Td, the range of t4 is expressed by the following formula (3), and the range of t5 is expressed by the following formula (4):
$$\begin{matrix}( formula 3 ) & \\ t 0 + 0.6 \times T d > t 4 \geq t 0 + 0.4 \times Td & ( 3 )\end{matrix}$$
$$\begin{matrix}( formula 4 ) & \\ t 0 + T d \geq t 5 \geq t 0 + 0.9 \times Td . & ( 4 )\end{matrix}$$

12. The combustion state detection device for the internal combustion engine according to claim 1, wherein
the determination unit changes the predetermined determination threshold value according to the operating state of the internal combustion engine.

13. The combustion state detection device for the internal combustion engine according to claim 2, wherein
the determination unit increases the peak voltage determination threshold value as the torque, rotational speed or intake pressure of the internal combustion engine rises.

14. The combustion state detection device for the internal combustion engine according to claim 3, wherein
the determination unit decreases the discharge period determination threshold value as the torque, rotational speed or intake pressure of the internal combustion engine rises.

15. The combustion state detection device for the internal combustion engine according to claim 5, wherein the determination unit increases the average voltage determination threshold value as the torque, rotational speed or intake pressure of the internal combustion engine rises.

16. The combustion state detection device for the internal combustion engine according to claim 9, wherein
the determination unit increases the voltage change rate determination threshold value as the torque, rotational speed or intake pressure of the internal combustion engine rises.

17. The combustion state detection device for the internal combustion engine according to claim 1, comprising:
an ECU which outputs an ignition signal for causing the spark plug to execute the ignition spark discharge and the detection spark discharge, wherein
the ECU includes the discharge feature amount acquisition unit and the determination unit.

18. The combustion state detection device for the internal combustion engine according to claim 1, wherein
the timing of the detection spark discharge is within a range from a 20° advance timing with respect to the time when the combustion mass ratio is 90% to a 40° retard timing with respect to the time when the combustion mass ratio is 90%.

19. The combustion state detection device for the internal combustion engine according to claim 1, wherein
the time taken to store magnetic energy in the ignition coil in the detection spark discharge is 0.2 ms to 1 ms.

20. The combustion state detection device for the internal combustion engine according to claim 1, wherein
when the timing of the detection spark discharge is on the advance side of the expansion stroke, the time taken to store magnetic energy in the ignition coil in the detection spark discharge is longer than when the timing of the detection spark discharge is on the retard side of the expansion stroke.

21. The combustion state detection device for the internal combustion engine according to claim 1, wherein
the torque of the internal combustion engine is high, the time taken to store magnetic energy in the ignition coil in the detection spark discharge is longer than when the torque of the internal combustion engine is low.

22. The combustion state detection device for the internal combustion engine according to claim 1, comprising:
a discharge information detection unit which detects a voltage value or a current value of an ignition coil connected to the spark plug, wherein
the discharge information detection unit detects a primary voltage value of the ignition coil.
